(19) United States
(12) Patent Application Publication
(10) Pub. No.: US 2017/0145606 A1
(43) Pub. Date: May 25, 2017

(54) NETTING MATERIAL

(71) Applicant: Nine IP Limited, Auckland (NZ)

(72) Inventors: Jonathan Dallas TOYE, Auckland (NZ); Gareth SCARFE, Auckland (NZ); Nicola Ann FORSTER, Auckland (NZ)

(21) Appl. No.: 15/303,290

(22) PCT Filed: Apr. 17, 2015
(86) PCT No.: PCT/IB2015/052804

§ 371 Date: Oct. 11, 2016

(30) Foreign Application Priority Data
Apr. 17, 2014 (NZ) 623985

(51) Int. Cl. D04B 21/10; A01G 13/02

(52) U.S. Cl. CPC D04B 21/10; A01G 13/0206; D10B 2507/02

(57) ABSTRACT

A netting material comprises a main portion and a netted window portion. The main portion has apertures of a first aperture size and shape, and the netted window portion has apertures of a second aperture size and shape. The apertures of the netted window portion are of sufficient size and shape to allow honey bees to pass through the netting material, whereas the apertures of the main portion are of sufficient size and shape to substantially prevent honey bees passing through the netting material.

### FIELD OF INVENTION

The invention relates to netting materials and particularly but not exclusively to netting materials for use as shade netting, wind screen netting or hail protection netting for example or in other agricultural applications.

### BACKGROUND

Shade netting, wind screen netting, or hail protection netting may be placed near plants to protect for example annual plants, perennial plants, fruit trees, or grape vines, from excessive sun, wind, or hail. Typically the netting is supported over the plant(s) and/or as a vertical and/or angled wall or walls near the plant(s), by for example cables or wires between posts positioned along the rows of plants in a garden, field crop, orchard or vineyard, or is draped over the plant(s) or is laid on the ground.

Bees are important to assist in pollination of many crop plants. Bee hives may be used in conjunction with netting installations to assist with pollination of plants.

### SUMMARY OF INVENTION

In one aspect, the present invention consists in a netting material having a length dimension and a width dimension smaller than the length dimension comprising:

a main portion comprising apertures of a first aperture size and shape,

a netted window portion comprising apertures of a second aperture size and shape, wherein

the apertures of the netted window portion are sufficient sized and shaped to allow bees to pass through the netting material and the first apertures are sufficiently sized and shaped to substantially prevent bees passing through the netting material.

In some embodiments, the netted window portion extends lengthwise along the netting material.

In some embodiments, the netted window portion extends substantially the full length of the netting material.

In some embodiments, the netted window portion covers 2 to 30%, or 5 to 30%, or 5 to 20%, or 5 to 15%, or 5 to 10% of the width of the netting material.

In some embodiments, the netted window portion is at or near a longitudinal edge of the netting material.

In some embodiments, the netting material comprises a netted window portion at or near both longitudinal edges of the netting material.

In some embodiments, the netting material comprises a netted window portion extending lengthwise along a region located between the longitudinal edges of the netting material.

In some embodiments, the netted window portion extends substantially around the perimeter of the netting material.

In some embodiments, the netted window portion covers 5 to 30%, or 5 to 20%, or 5 to 15%, or 5 to 10% of the width of the netting material and the same or similar width at lateral edges of the netting material.

In some embodiments, the netted window portion is between 80 mm to 2 m, or 100 mm to 1.5 m, or 200 mm to lm wide, or 400 mm to 600 mm wide, or about 0.5 m wide.

In some embodiments, the netted window portion material extends longitudinally along or near the centre of the width of the netting material.

In some embodiments, the netted window portion comprises a knitted pillar construction, or a square construction, the pillars of the pillar or square construction running lengthways along the netting material.

In some embodiments, both the main portion and the netted window portion comprises a knitted pillar construction, the pillars of the pillar construction running lengthways along the netting material.

In some embodiments, the netted window portion comprises a diamond construction.

In some embodiments, both the main portion and the netted window portion comprise a diamond construction, the diamond construction having diamond shaped primary apertures, and where yarns extend through or cross over the primary apertures of the diamond construction of the main portion.

In some embodiments, yarns forming the netted window portion are stronger or of greater denier than yarns forming the main portion.

In some embodiments, the main portion and the netted window portion are formed separately and subsequently joined together along a longitudinal edge of the main portion to form the netting material.

In some embodiments, the netted window portion comprises a longitudinal edge region having a higher density construction than a remainder of the netted window portion, the main portion of the netting joined to the higher density construction of the netting window portion.

In some embodiments, the netted window portion comprises a knitted pillar construction and the pillars in the longitudinal edge region are spaced closer together than in the remainder of the netting window portion.

In some embodiments, the netted window portion and the main portion of the netting are stitched together.

In some embodiments, the netting material comprises a window identifier to assist bees in identifying the netted window portion.

In some embodiments, the window identifier comprises window identification yarns, said window identification yarns being yarns that, from a bees perspective, are different in colour to the yarns of the main portion of the material.

In some embodiments, yarns which form the netted window portion comprise window identification yarns.

In some embodiments, the yarns which form the netted window portion are substantially colourless.

In some embodiments, the window identification yarns are in the form of a lay-in laid into knitted yarns of the netted window portion.

In some embodiments, the netted window portion has a length longer than its width and the window identification yarns form a band or bands of colour located to frame longitudinal edges of the netted window portion.

In some embodiments, the main portion and netted window portion are formed from separate sections of netting and the window identification means is a yarn which is used to stitch said main portion and netted window portion together.

In some embodiments, the main portion of the netting is white, black, fawn, grey or colourless or substantially colourless.

In some embodiments, the window identification yarns are of colour ultra violet, indigo, violet, blue, purple, bee purple, green, yellow or orange or red, or a combination of such colours.

In some embodiments, the window identification yarns are black (from a bees perspective) or red.

In some embodiments, the netted window portion is coloured red of a reflecting light wavelength of greater than 620 nm.

In some embodiments, the netted window portion absorbs more than 50%, or more than 70%, or more than 85%, or more than 90%, or more than 95% on average, of solar radiation across the wavelength range 280 to 620 nm.

In some embodiments, the yarns forming the main and netted window portions of the netting are white (from a human perspective) and the window identification yarns (whether they form the netted window portion itself or otherwise) differ in their reflectivity profile across the wavelength range 280 to 400 nm compared to the yarns of the main portion, and/or differ in their reflectivity profile across the wavelength range 400 to 620 nm compared to the yarns of the main portion.

In some embodiments, the yarns forming the main and netted window portions of the netting are white (from a human perspective) and the window identification yarns (whether they form the netted window portion itself or otherwise), on average, reflect more or less solar radiation across the wavelength range 280-400 nm, and/or reflect more or less solar radiation across the wavelength range 400-620 nm.

In some embodiments, the apertures of the main portion are of a aperture size less than 1 mm or 1 mm to 6 mm, or 1 mm to 5 mm, or 2 mm to 4 mm, or 2 mm to 3 mm.

In some embodiments, the main portion of the netting comprises hexagonal, diamond or triangular apertures.

In some embodiments, the apertures of the netted window portion are of a size such that the largest ellipsoid shape they may contain has:

a major axis of length 6 mm to 40 mm, or 8 mm to 35 mm, or 10 mm to 30 mm, or 15 mm to 25 mm, or 18 mm to 22 mm, and

a minor axis of size 6 mm to 40 mm, or 6 mm to 18 mm, or 6 mm to 15 mm, or 6 mm to 12 mm, or 8 mm to 20 mm, or 8 mm to 18 mm, or 8 mm to 15 mm, or 8 mm to 12 mm.

In some embodiments, the apertures of the netted window portion have a size and shape sufficient to allow a honey bee to pass through by crawling/walking.

In some embodiments, the apertures of the netted window portion have an aperture size and shape sufficient to allow a honey bee to pass through in flight.

In some embodiments, the netted window portion comprises square or rectangular apertures.

In some embodiments, spacing between pillars in the longitudinal edge regions is 1 mm to 6 mm, or 2 mm to 5 mm, or 3 mm to 4 mm and the spacing between pillars in the remainder of the netted window portion is 6 mm to 20 mm, or 7 mm to 19 mm, or 8 mm to 18 mm, or 9 mm to 17 mm, or 10 mm to 16 mm, or 11 mm to 15 mm or 12 mm to 14 mm.

In some embodiments, the netting material is knitted or woven from monofilaments.

In some embodiments, the main portion of the netting is shade netting. In some embodiments, the main portion of the netting is wind screen netting.

In some embodiments, the apertures of the netted window portion are sufficiently small to prevent birds passing through the netting material.

In some embodiments, the netted window portion is knitted or woven from coloured multi filaments or monofilaments.

In some embodiments, the coloured multi filaments or monofilaments are coloured ultra violet, indigo, violet, blue, purple, bee purple, green, yellow or orange or red, or a combination of such colours.

In some embodiments, the netting material comprises:

a plurality of primary yarns knitted to form a mesh construction having an arrangement of primary apertures of the second size throughout the netting material in both the main portion and the netted window portion of the netting material, the primary apertures defined by yarn intersections and yarn connecting portions between yarn intersections, and

a plurality of secondary yarns, the secondary yarns crossing over the primary apertures in the main portion of the netting to form secondary apertures of the first size within the primary apertures in the main portion of the netting.

In some embodiments, the secondary yarns are retained in the main portion of the netting material by the knitting or knotting or looping of the primary yarns without being knitted, knotted or looped in the yarn connecting portions.

In some embodiments, each of a majority of the yarn connecting portions in the main portion of the netting comprising:

a secondary yarn which is a lay-in yarn,

a primary yarn being knitted, knotted or looped around the secondary yarn in the yarn connecting portion,

wherein each secondary yarn passes part way along a yarn connecting portion and extends from the yarn connecting portion to cross over a primary aperture to another yarn connecting portion defining the primary aperture so that at least one or two secondary yarns cross over each primary aperture to define at least two or four secondary apertures in each primary aperture.

In some embodiments, the plurality of primary yarns each extend along a length of the netting in an approximate zig-zag path with alternating yarn intersections and connecting yarn portions, adjacent primary yarns knitted, knotted or looped together at the yarn intersections.

In some embodiments, the plurality of secondary yarns each extend along a length of the netting material in an approximate zig-zag path.

In some embodiments, each secondary yarn extends along the length of the netting material in an approximate zig-zag path at a zig-zag pitch and amplitude the same as a zig-zag pitch and amplitude of the primary yarns, the zig-zag path of each secondary yarn offset along a connecting yarn portion of the mesh construction in the main portion of the netting by a distance so that each secondary yarn crosses over a primary aperture and through yarn intersections along the length of the netting material in the main portion of the netting.

In some embodiments, in a repeating portion of the zig-zag path each secondary yarn extends from a yarn intersection at a first end of a yarn connecting portion, partway along a yarn connecting portion, across a primary aperture, and partway along the yarn connecting portion on the opposite side of the primary aperture to a yarn intersection at a second end of the yarn connecting portion of the opposite side of the primary aperture.

In some embodiments, the secondary yarn is not knotted or looped in the yarn intersections of the netting material.

In some embodiments, each of a majority of the connecting yarn portions in the main portion of the netting comprising:

two or more secondary yarns, each secondary yarn not knotted in the connecting yarn portion,

a primary yarn being knitted, knotted or looped around the two or more secondary yarns in the connecting yarn portion,

wherein the secondary yarns pass part way along the connecting yarn portion and extend from the connecting yarn portion to cross over a primary aperture in a spaced apart relation to another connecting yarn portion defining the primary aperture so that at least two pairs of secondary yarns cross over each primary aperture to define at least nine secondary apertures in each primary aperture.

In some embodiments, each of a majority of the connecting yarn portions comprising:

one pair of secondary yarns, each secondary yarn not knotted in the connecting yarn portion,

a primary yarn being knitted, knotted or looped around the pair of secondary yarns in the connecting yarn portion,

wherein the secondary yarns pass part way along the connecting yarn portion and extend from the connecting yarn portion to cross over a primary aperture in a spaced apart relation to another connecting yarn portion defining the primary aperture so that two pairs of secondary yarns cross over each primary aperture to define nine secondary apertures in each primary aperture.

In some embodiments, the secondary yarns pass part way along the connecting yarn portion and extend from the connecting yarn portion to cross over a primary aperture in a spaced apart relation to a connecting yarn portion on an opposite side of the primary aperture.

In some embodiments, the secondary apertures and the primary apertures have the same or similar aspect ratio.

In some embodiments, the netting material comprises rows of the yarn intersections adjacent to one another in a first axis or direction across the netting, and in immediately adjacent rows of yarn intersections in a second direction substantially orthogonal to said first direction, the yarn intersections of the adjacent rows are staggered relative to one another.

In some embodiments, the netting comprises rows of yarn intersections, said rows extending across either the width of the netting material or along the length of netting material, the yarn intersections of each row of yarn intersections being staggered or offset with respect to its adjacent row of yarn intersections.

In some embodiments, the first direction is across a machine or manufacturing axis or direction of the netting and the second direction is the machine or manufacturing axis or direction of the netting.

In some embodiments, the primary apertures have four sides, each primary aperture defined by four yarn connecting portions.

In some embodiments, said material is of pillar knit construction comprising pillars and crossover yarns crossing back and forth between and along the length of the pillars, and

wherein the pillars and/or the crossover yarn(s) in the main portion of the netting are arranged such that the main portion of the netting comprises apertures of a size and shape sufficient to substantially prevent bees passing through, and

wherein the pillars and/or the crossover yarn(s) in the netted window portion of the netting are arranged such that the netted window portion of the netting comprises apertures of a size and shape sufficient to allow bees to pass through.

In some embodiments, the pillars of the netted window portion are spaced apart by about 18 to 26 mm and the pillars of the netted window portion are spaced apart by about 6-10 mm.

In a second aspect, the present invention consists in a netting material having a length dimension and a width dimension smaller than the length dimension comprising:

a main portion comprising apertures of a size and shape that bees may pass through but, from a bee's perspective, comprise a colour that deters them from doing so such that there is little or no bee passage through the netting, and

a netted window portion comprising apertures of a size and shape that bees may pass though and, from a bee's perspective, comprise a colour that bees will, when compared to the main portion, more willingly pass though.

In some embodiments, the apertures of the netted window portion are of a size and shape and, from a bee's perspective, comprise a colour that that bees will pass through such that there no substantial impediment to bees passing through.

In some embodiments, the apertures of the main portion and the netted window portion are of the same size and shape.

In various embodiments, the second aspect may comprise one or more of the features described above in relation to the first aspect of the present invention.

In a third aspect, the present invention consists in a netting material having a length dimension and a width dimension much smaller than the length dimension comprising:

a main portion comprising apertures of a first aperture size,

a netted window portion comprising apertures of a second aperture size, wherein the second aperture size is larger than the first aperture size,

the apertures of the second size sufficiently large to allows bees to pass through the netting material and the apertures of the first size sufficiently small to prevent bees passing through the netting material.

In various embodiments, the third aspect may comprise one or more of the features described above in relation to the first aspect of the present invention.

In a fourth aspect, the present invention consists in a method of treating a plant or fruit or vegetables thereon which comprises providing over and/or adjacent the plant a netting material according to the first, second or third aspect of the present invention described above.

In a fifth aspect, the present invention consists in an installation of netting material comprising netting walls and a netting ceiling to form a netted enclosure, wherein one or more of the netting walls or netting ceiling comprises a netting material with a main portion and a netted window portion according to the first, second or third aspect of the present invention described above.

In some embodiments, one or more of the netting walls comprise a netting material with a main portion and a netted window portion according to the first, second or third aspect of the present invention described above.

In some embodiments, each of the netting walls comprises a netting material with a main portion and a netted window portion according to the first, second or third aspect of the present invention described above.

In some embodiments, each of the netting walls comprises a netting material with a main portion and a netted window portion at the longitudinal edge of the netting material at the top of the wall.

In some embodiments, the ceiling netting comprises a netting material with a main portion and a netted window portion around the perimeter of the netting material.

In some embodiments, each of the netting walls comprises a netting material with a main portion and a netted window portion at the longitudinal edge of the netting material at the top of the wall, so that the netted enclosure has a netted window portion spanning a top corner area of the netted enclosure.

In some embodiments, the installation is installed to enclose rows of plants, said rows being spaced apart from each other, wherein the ceiling netting comprises a netted window portion arranged such that it located above the space between the rows.

In some embodiments, the main portion of the ceiling netting is a first colour and the main portion of the wall netting is a second colour different to the first colour.

In some embodiments, the netted window portions are a third colour different to the first and second colours.

In some embodiments, the main portion of the ceiling netting is white and the main portion of the wall netting is grey.

In some embodiments, the netted window portions are red, blue, green or yellow or a combination of these colours.

In some embodiments, the installation includes one or more bee hives inside the netted enclosure.

The term “yarn” as used in this specification and claims, unless the context suggests otherwise means multi or mono filament yarn, threads or fibres. The term “yarn” unless the context suggests otherwise, is intended to include longitudinally extending single filament elements having four sides when viewed in cross-section, such as a rectangular or square cross-section, also longitudinally extending elements having a multisided cross-section such as a triangular or hexagonal cross-section for example, and also longitudinally extending elements having a circular or oval or similar cross-section (sometimes referred to hereafter as monofilament). The term yarn includes tape, unless the context suggests otherwise.

The yarns may be formed from any suitable polyolefin. In particular they may be comprised of thermoplastic polyolefins such as polyethylene or polypropylene, for example, or a mixture thereof, or an ethylene alpha-olefin, or a polyester, or a biopolymer, or a blend of any of the foregoing. Certain plastics are particularly useful when present as minor or major components. Ethylene vinyl acetate (EVA), ethylene butyl acrylate (EBA), thermoplastic polyurethane (TPU), ethylene methyl acrylate (EMA) and elastomers are useful for imparting elasticity and other properties. Polyamides can be used to add strength. Polyesters, polyethylene terephthalate (PET), polymethylmethacrylate (PMMA) and polycarbonate. Starch and other plant polymers are useful to increase biodegradability. Alternatively the yarns may comprise in part or whole of paper, wood or cellulose fibre, starch based polymers, casein, latex or in any combination of the above and/or with petroleum derived plastic polymers. The polymer or polymer blend may incorporate agents such as one or more pigments, UV stabilisers, or processing aids.

A ‘lay-in’ yarn, unless the context suggests otherwise, is a yarn that is knitted or woven through at least some of the yarn intersections and/or connecting portions defining the primary apertures that make up the mesh construction of a knitted netting material, said yarn intersections and/or connecting portions forming the basic knit structure of such material, and is additional to, rather than a basic structural element of said basic knit structure. Optionally, the lay-in yarn is not looped back on itself more than 180 degrees in the primary direction of travel or knitting direction. Sometimes the lay-in yarn may loop more than 180 degrees in the primary direction of travel of knitting direction, for example, it may loop 360°. If the lay-in yarn is removed the net's inherent structure will stay intact. It is supported by the basic yarn knitted structure. A lay-in yarn is also referred to herein as a “secondary yarn”. A lay-in yarn may be arranged to cross a primary aperture (term defined below), or may be arranged to follow the perimeter of a primary aperture.

The term “netting” or “netting material” means material having a cover factor (as herein defined) of up to 80% but typically less than 70%, 60%, 50%, 40%, 30%, 20%, 10% or 5% or 2%. The term includes both knitted and woven nettings. The term also includes extruded netting, comprising crossed strands heat welded or chemically bonded together.

The phrase “cover factor” as used herein means the percentage of the overall area of the netting material which is formed by yarns, judged from perpendicular to the plane of the netting when laid out flat, as opposed to air space in between the netting. Thus if a netting has a cover factor of 30% then the air space through the netting would be 70% of the total area of the netting.

The phrase “aperture size” as used in this specification, unless the context suggests otherwise, is intended to refer to the diameter of the largest circle that can be scribed within an aperture in a mesh when the mesh is taut but not stretched in both a lateral and a longitudinal direction, or in a state to which the netting may be reasonably expected to be stretched once installed. For example, for a square aperture, the size of the aperture is the length of a side, and for a rectangular aperture, the aperture size is the length of the shorter side of the aperture. So the aperture size of a square aperture with 5 mm sides is 5 mm, and the aperture size of a 5 mm by 10 mm aperture is also 5 mm. An equilateral triangle with sides of approximately 8.7 mm and the aperture size of a hexagonal aperture with sides of approximately 2.9 mm are also examples of apertures having a size of 5 mm. An aperture may be irregularly shaped, the above regularly shaped apertures are provided as examples only. When the phrase “aperture size”, or grammatical variations of the phrase, are used with respect to a region of netting material, the phase refers to the average aperture size of that region, unless the context suggests otherwise. The applicant recognises that in use a netting may installed such that it is stretched so that the apertures are larger than what they would be if the netting is in a taught but unstretched state. Nettings that have been installed such that they have aperture sizes that fall within the ranges claimed herein, or nettings that may be reasonably stretched such that have aperture sizes that fall within the ranges claimed herein, should be considered to fall within the ranges claimed herein.

The term “primary aperture” is used in this specification. The term is used in the context of knit patterns comprising a lay-in yarn, and is used to distinguish the apertures of the basic knit structure (i.e. ignoring lay-in yarns) from the apertures of the knit structure formed by the lay-in yarns. For example, when considering a diamond basic knit pattern with a lay-in yarn dividing each diamond shaped aperture of the knit pattern in half, the primary aperture is the diamond shaped aperture, which is divided by the lay-in yarn to form two smaller apertures.

The term “basic knit structure” is also used in this specification. The term is used in the context of nettings comprising a lay-in yarn(s), and refers to the knit pattern ignoring any lay-in(s).

A reference to “bees” or “honey bees” in this specification and claims is intended to mean “worker bees” (female bees), rather than drone bees (male bees) or queen bees, unless the context suggests otherwise.

The term “colour” as used in this specification is generally used in the sense of colour viewed from the human perspective, and the term should be read in this light unless the context suggests otherwise. In some instances the specification refers to ultraviolet as a “colour”. The reader will understand that in such instances ultraviolet is being considered as a colour from a bee's perspective, even though the human eye may not be able to see it. The term “colour” as used herein includes black, white, grey and clear. When comparing colours, colourless is considered to be a different colour to a coloured yarn.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

As used herein the term “and/or” means “and” or “or”, or both.

As used herein “(s)” following a noun means the plural and/or singular forms of the noun.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples only.

### BRIEF DESCRIPTION OF THE DRAWINGS

The invention is further described by way of example with reference to the accompanying schematic drawings in which:

FIG. 1 shows a section of one form of prior art knitted diamond monofilament netting. The netting has a cover factor of approximately 5-15%. The netting is knitted in a diamond structure.

FIG. 2 shows a section of another form of prior art knitted diamond monofilament netting with four cross over (or lay-in) yarns. The netting has a cover factor of approximately 10-20%. The netting is knitted in a diamond structure but with four additional strands of monofilament across the diamond.

FIG. 3 shows a section of a form of prior art knitted diamond shaped monofilament netting. The netting has a cover factor of approximately 10-20%. The netting is knitted in a diamond shaped structure.

FIG. 4 shows a section of one form of prior art knitted hexagonal monofilament netting. The netting has a cover factor of approximately 10-20%. The netting is knitted in a hexagonal structure.

FIG. 5 shows a section of a form of prior art knitted pillar based (or pillar construction) monofilament netting. The netting has a cover factor of approximately 20-30%. The pillars are joined by knitted monofilaments across the pillars.

FIG. 6 shows a section of another form of prior art knitted pillar based monofilament netting. The netting has a cover factor of approximately 5-10%. The pillars are similar size to FIG. 5 and are joined by monofilaments that loop through the pillars.

FIG. 7 shows a section of one form prior art woven monofilament netting. The netting has a cover factor of approximately 20-30%, with small apertures.

FIG. 8 shows a section of one form prior art knitted monofilament netting. The netting has a cover factor of approximately 40-50%, with smaller apertures.

FIG. 9 shows a section of one form of prior art knitted monofilament netting, having a cover factor of approximately 30-40%.

FIG. 10 shows a section of one form of prior art knitted monofilament netting, having a cover factor of approximately 40-50%.

FIG. 11 shows an example installation of a netting material according to some embodiments of the present invention, comprising a netted window portion located high on the walls of the installation.

FIG. 12 shows another example installation of a netting material according to some embodiments of the present invention, showing a netted window portion located around the perimeter of the ceiling of the installation.

FIG. 12A shows another example installation of a netting material according to some embodiments of the present invention, showing a netted window portion located to extend lengthwise along a central portion of the netting's (or installation's) width.

FIG. 12B shows another example installation of a netting material according to some embodiments of the present invention, showing a netted window portion located to extend lengthwise along the longitudinal edges of the netting's (or installation's) width.

FIG. 12C shows another example installation of a netting material according to some embodiments of the present invention, showing a netted window portion located to extend lengthwise along the longitudinal edges of the installation's ceiling's width, as well as along a central lengthwise extending portion of the ceiling, as well as high on the walls of the installation's walls.

FIG. 13 shows yet another example installation of a netting material according to some embodiments of the present invention, showing a netted window portion located both high on the walls of the installation and around the perimeter of the ceiling.

FIG. 14 shows yet another example installation of a netting material according to some embodiments of the present invention showing a netted window portion located at a position a distance from a longitudinal edge of a the netting material.

FIG. 15 is a schematic view showing a section of a netting material according to some embodiments. The portion illustrated is a full width of the netting material.

FIG. 16 is a close up view of a section of netting material according to some embodiments.

FIG. 17A is a plan view of a portion of netting in in accordance with an embodiment of the invention.

FIG. 17B is a plan view of a portion of netting in in accordance with an embodiment of the invention, with primary yarns of the netting shown in outline.

FIG. 18 is a plan view of a single intersection of netting depicted in FIGS. 17A and 17B.

FIG. 19A is a plan view of a larger portion of netting as depicted in FIGS. 17A and 17B.

FIG. 19B is a plan view of a larger portion of netting as depicted in FIGS. 17A and 17B with primary yarns of the netting shown in outline and with the path of certain secondary yarns of the netting indicated.

FIG. 20 is a plan view of a portion of netting as depicted in FIGS. 17A and 17B but with bending or curvature of secondary yarns in the netting exaggerated for ease of displaying the path of the secondary yarns through the netting material.

FIG. 21 shows a section of netting material including a netted window portion and a main portion according to some embodiments of the present invention. The netting is of a diamond construction.

FIG. 22 shows a section of netting material including a netted window portion and a main portion according to some embodiments of the present invention. The netting is of a pillar knit construction.

FIG. 23 shows a section of netting material including a netted window portion and a main portion according to some embodiments of the present invention. The main portion of the netting is of a pillar knit construction and the netted window portion is of different construction.

FIG. 24 is a graph representing bee passage through a netting as netting aperture size changes.

### DETAILED DESCRIPTION OF EMBODIMENTS

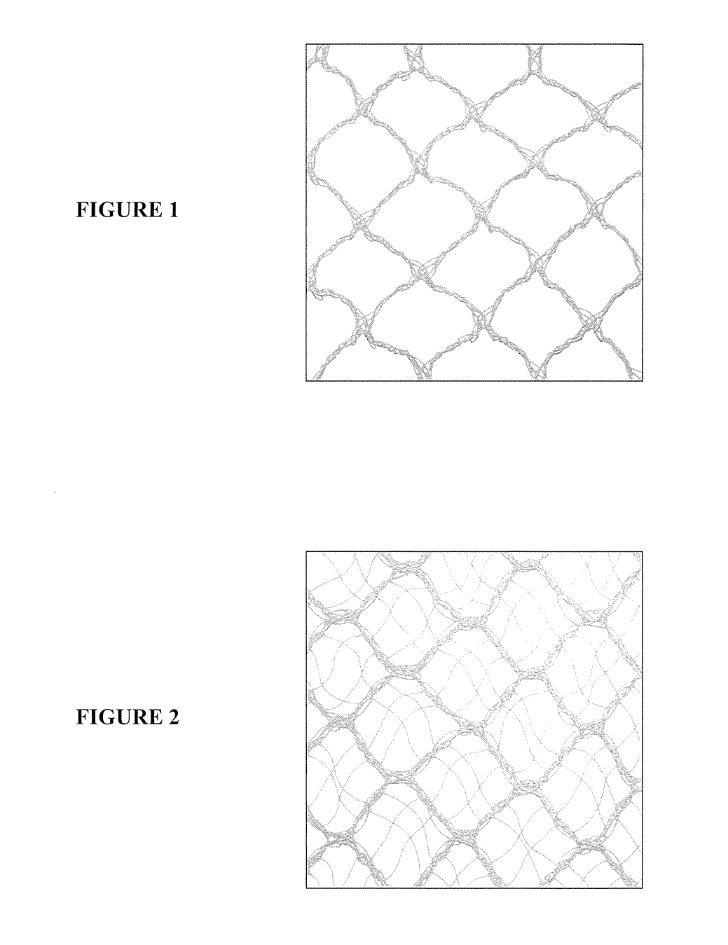

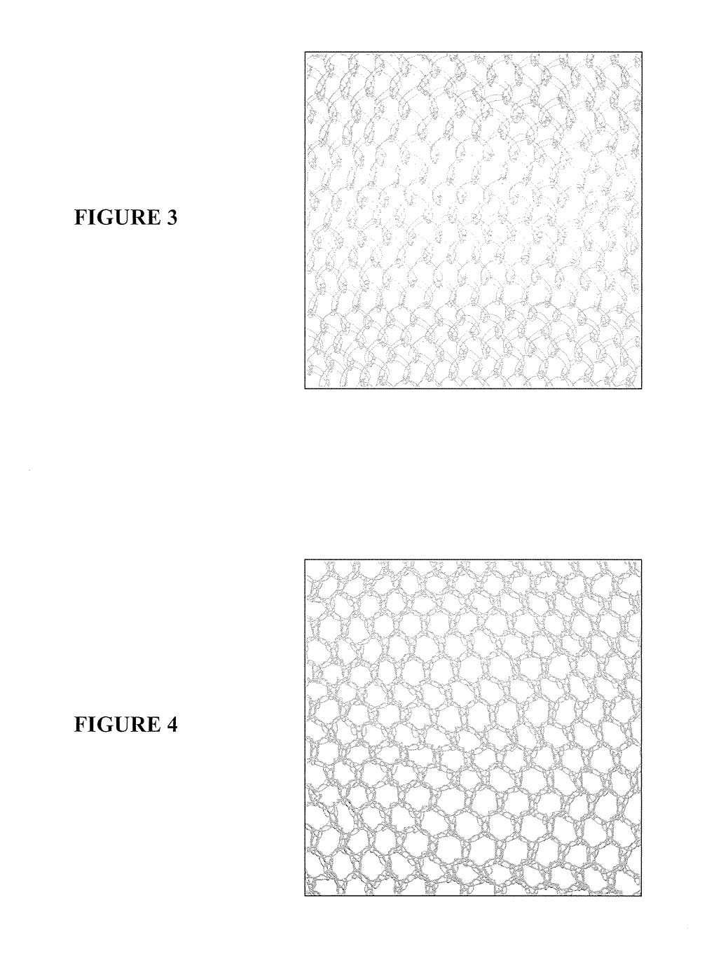

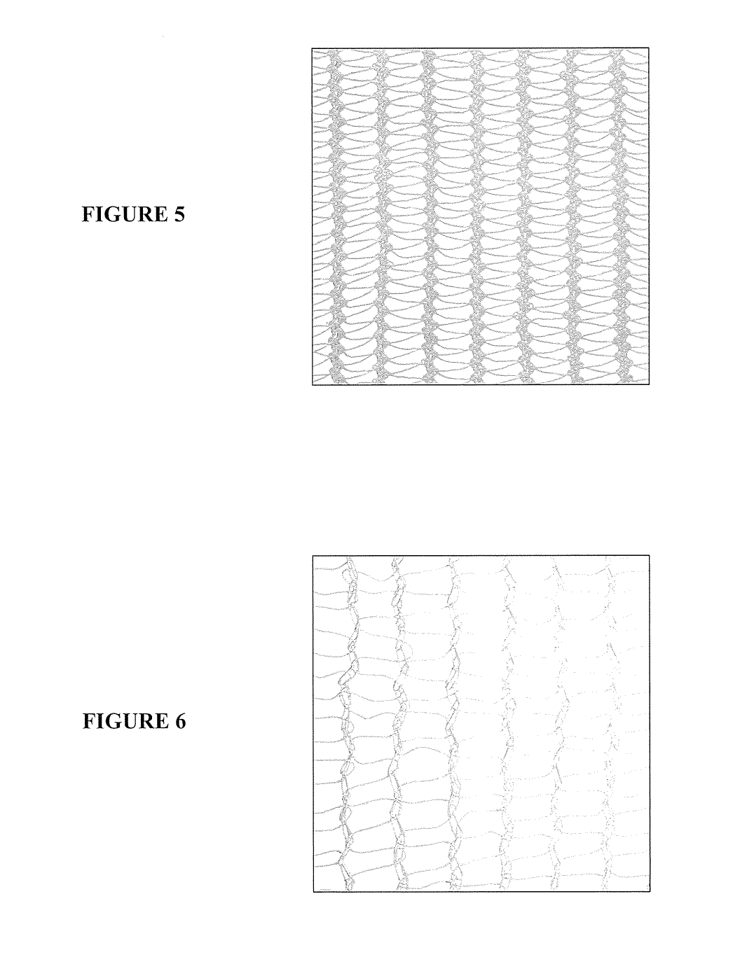

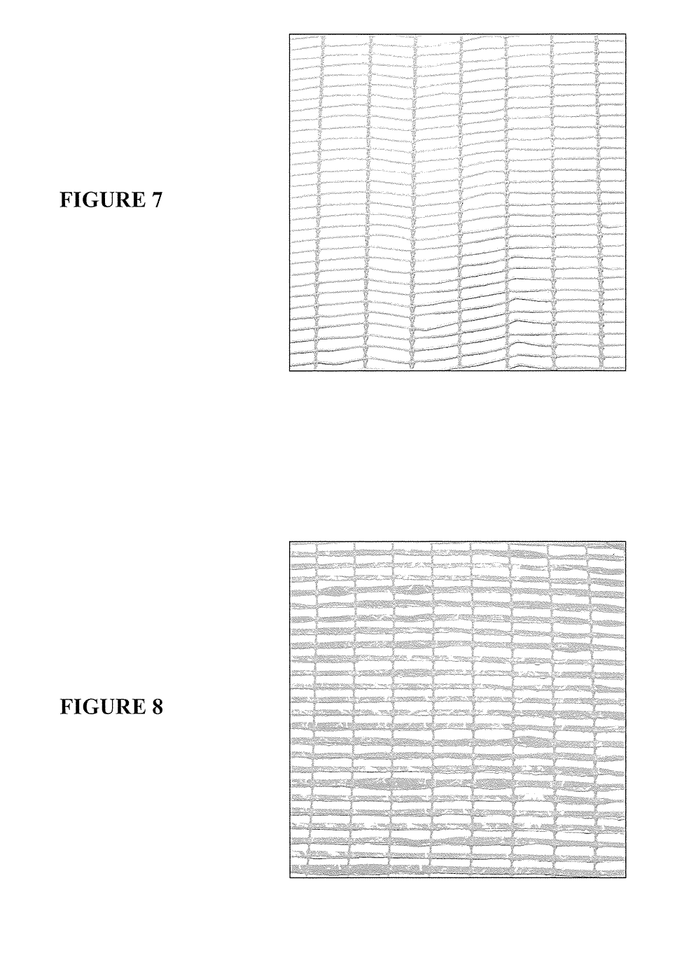

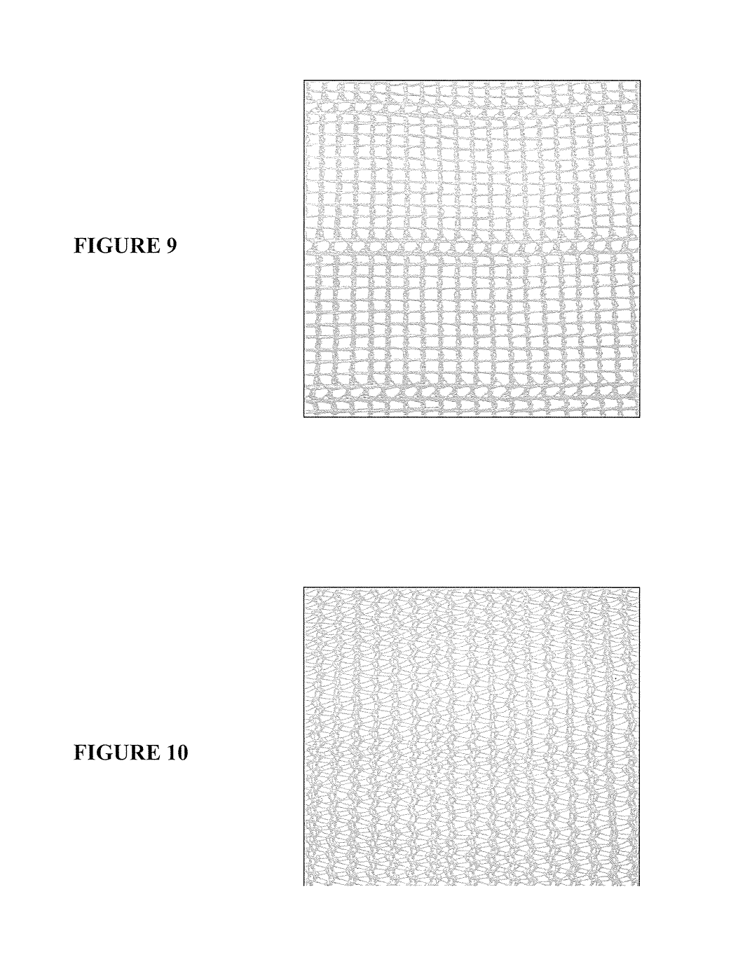

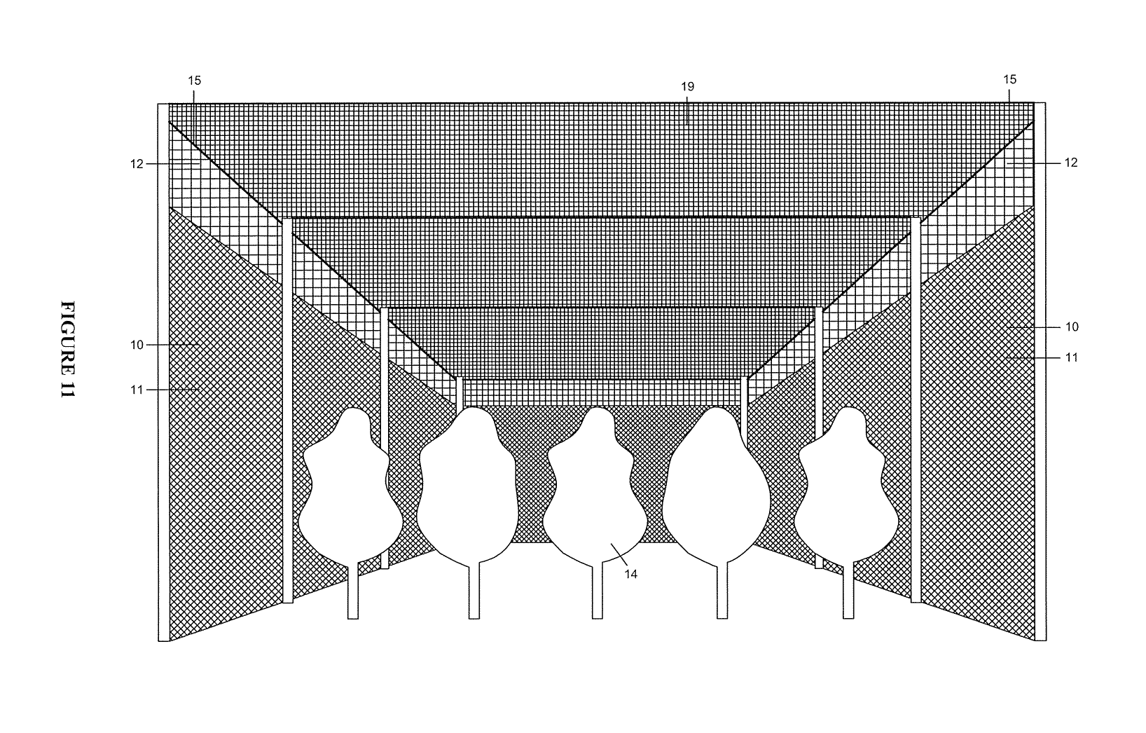

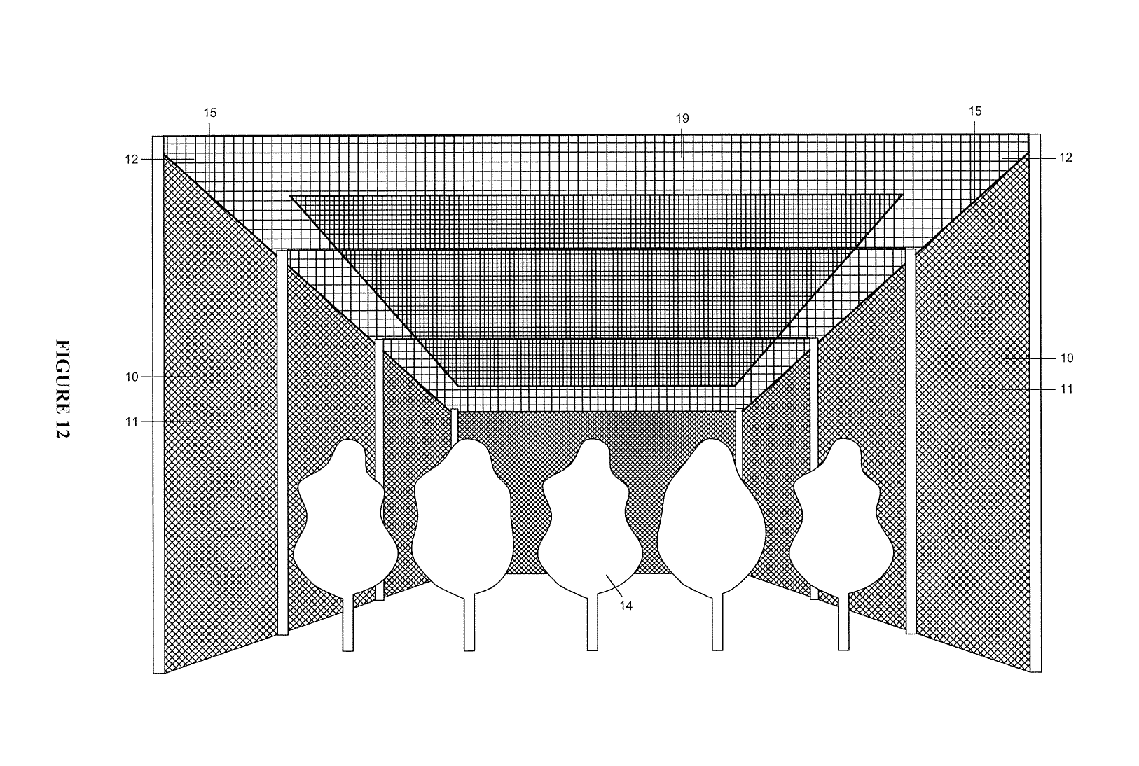

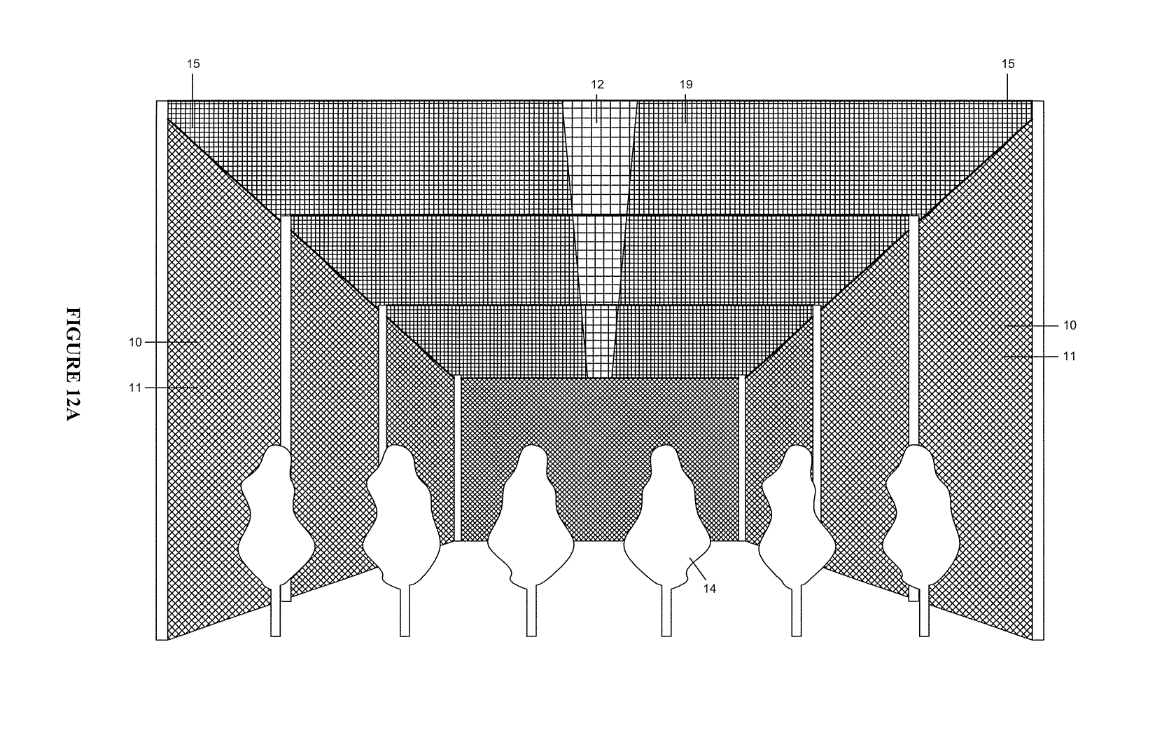

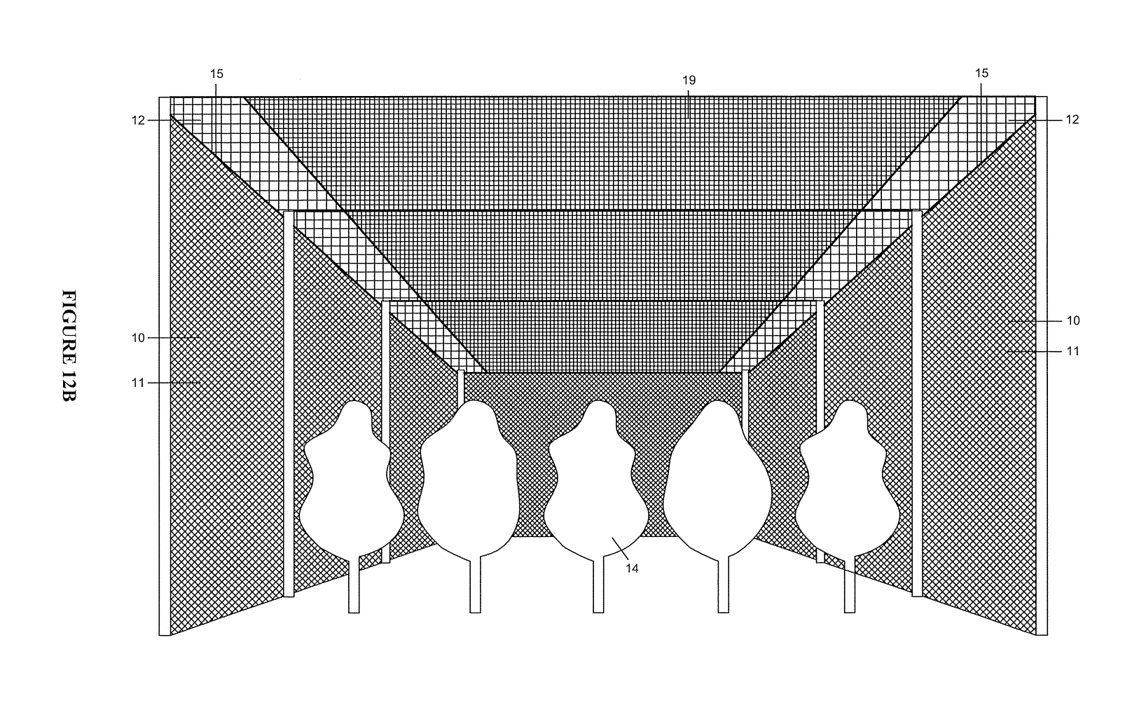

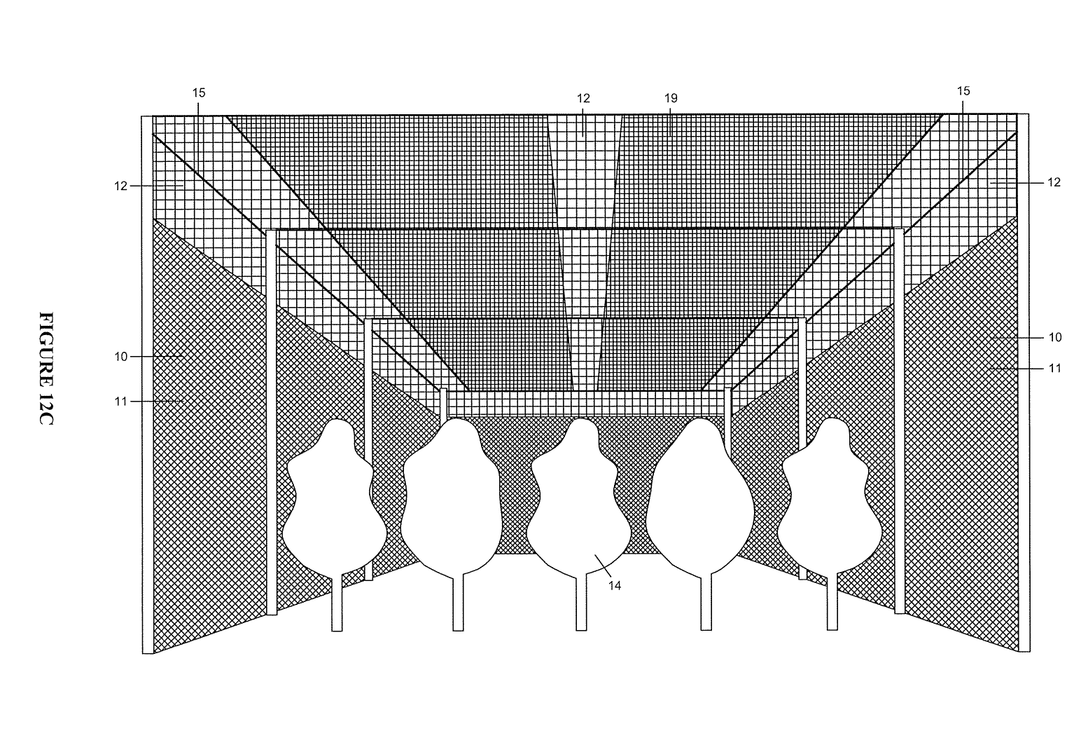

FIGS. 1 to 10 show by way of example sections of prior art netting materials. Typically the netting is supported over the plant(s), for example oriented horizontally above plants, and/or as a vertical and/or angled wall or walls near the plant(s), or on the ground itself, by for example cables or wires between posts positioned along the rows of plants in a garden, field crop, orchard or vineyard, or is draped over the plant(s) as bird netting, insect netting (as for example bee exclusion netting), shade netting, windbreak netting, or hail protection. Netting may be placed near plants to protect for example annual plants, perennial plants, fruit trees, or grape vines, vegetable plants, from birds, insects, excessive sun, wind, or hail.

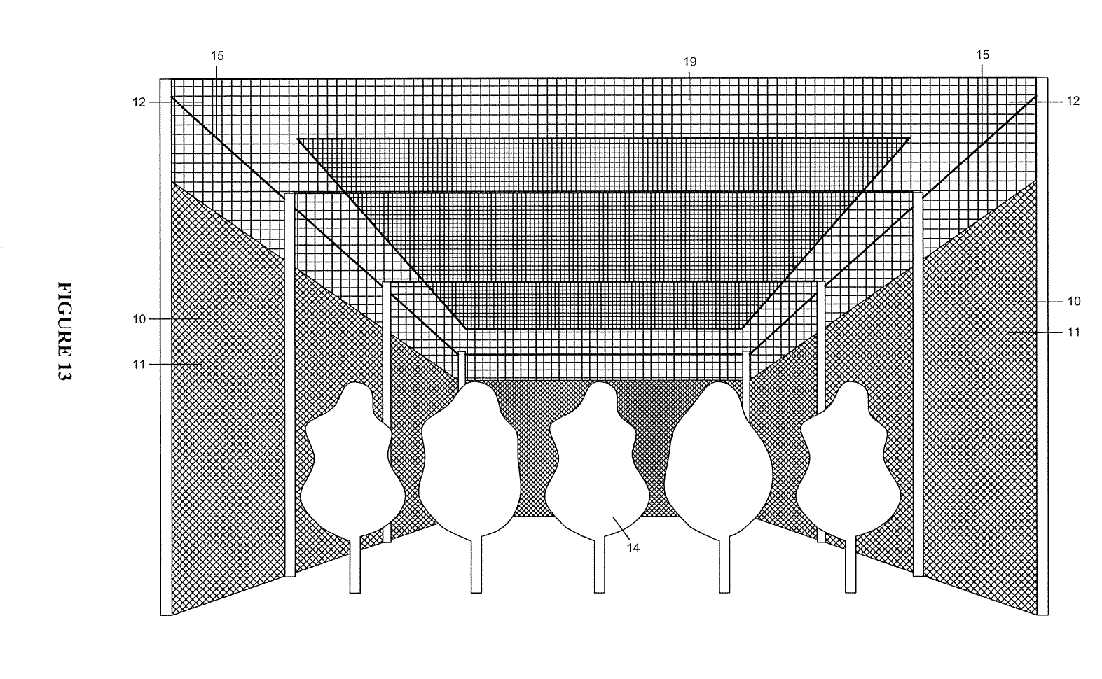

Cables or wires or ropes or other securing devices or fasteners are coupled to the netting to anchor the netting to the ground or support structure. The apertures of the netting material may not provide sufficient strength to allow fasteners to hook or secure directly to or through the apertures of the netting. For securing the netting material in place, eyelets may be integrally knitted into the netting material or eyelets may be otherwise provided to the netting, for example via reinforcing material provided to the with eyelets formed in the reinforcing material. Cables or wires or ropes or other securing devices or fasteners tie to or pass through or hook or otherwise engage with the eyelets.

Where netting material is used as windbreak netting typically the netting material is supported by cables and posts as a wall or walls near the plant(s). A field of trees or plants may be enclosed by a perimeter of vertical windbreak netting to shelter the trees or plants from all directions. In some installations, netting may also be provided as a ceiling over the trees or plants, so that the trees or plants are enclosed from all sides and also from above. An example installation is illustrated in FIG. 11 where the trees 14 are sheltered from all sides (only three of four sides illustrated) by netting walls 10 and also from above by a netting ceiling 19. Wind speed reduction throughout an orchard through the use of windscreen netting allows improved fruit finish and fruit pack-out.

FIGS. 11 to 14 use a single tree to represent a row of trees. The reader will understand that while only 5 or 6 rows are represented, an installation may cover many more rows, for example 60 rows.

In windscreen netting, typically the apertures size of the netting material is less than about 6 mm, and preferably in the range of 1 mm to 6 mm, or 1 mm to 5 mm, or 2 mm to 4 mm, or 2 mm to 3 mm. Aperture size useful for reducing wind speed is typically too small to allow bees to pass through the netting, resulting in reduced bee activity.

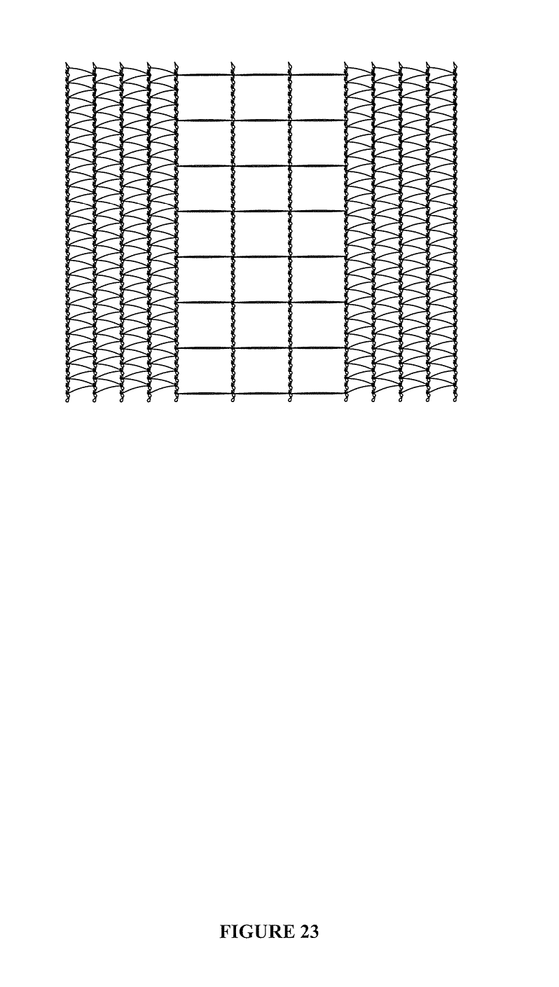

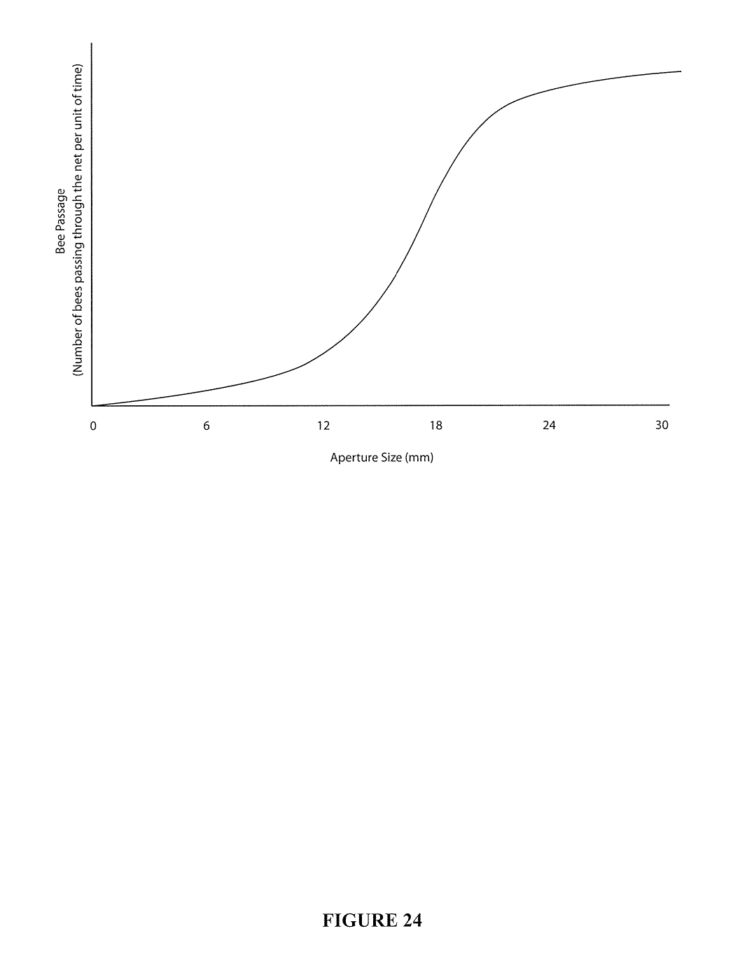

Netting material according to various embodiments of the present invention is described with reference to FIGS. 11 to 23. In a netting material according to the present invention, a main portion 11 of the netting has apertures of a size that provides protection to plants or trees, for example from wind, sun or hail. In one preferred use, the main portion of the netting has an aperture size suitably small enough to shield trees and plants from wind. That is the main portion 11 of the netting material is a wind protection netting material. For example, the aperture size of the main portion of the netting is 1 mm to 6 mm, or 1 mm to 5 mm, or 2 mm to 4 mm, or 2 mm to 3 mm, or in some instances less than 1 mm. The apertures of the main portion of the netting are of size and shape sufficiently small to prevent bees passing through.

Bees may be able to wriggle through an aperture size of for example 4.5 to 6 mm. Bees may attempt to pass through such a small aperture, for example if they are particularly hungry or are otherwise stressed. However, typically bees will not attempt to pass through apertures of this size, even though they are physically able to. Also, a bee may damage itself when passing through an aperture only slightly bigger than the bee's body, for example a wing may be torn.

An aperture is considered to be sufficiently small, or of sufficient size and shape, to prevent bees passing through when bees will not attempt to pass through the aperture given normal behaviour, even though bees may be able to physically pass through the aperture, for example when in a stressed state. Thus the aperture size, or size and shape, in the main portion of the netting material may provide a behavioural barrier to bees, rather than a totally mechanical barrier.

In a netting material according to the present invention, a netted window portion 12 is provided together with the main portion 11 of the netting. In the netted window portion, the apertures are of a size sufficiently large, or of sufficient size and shape, to allow bees to pass through the netting material given normal behaviour. A netting material according to the present invention thus provides protection to plants or trees while simultaneously allowing bees to enter and exit the protected area of the trees via the netted window area to maintain or improve pollination levels or to give normal bee activity. In some embodiments the aperture size in the netting window portion of the netting is 6 mm to 24 mm, or 8 mm to 22 mm, or 10 m to 20 mm, or 12 mm to 19 mm, or 14 mm to 19 mm, or 16 mm to 19 mm. In some embodiments the aperture size for the netted window is about 10 mm. In some embodiments it is about 13.5 mm. In some embodiments it is about 18 mm. In some embodiments the aperture size in the netting window portion of the netting is 6 mm to 20 mm, or 7 mm to 19 mm, or 8 mm to 18 mm, or 9 mm to 17 mm, or 10 mm to 16 mm, or 11 mm to 15 mm or 12 mm to 14 mm. In some embodiments the aperture size for the netted window is about 10 mm.

While not wishing to be bound by any particular theory, the applicant believes that allowing bees (or at least some bees, especially those with an instinctual behaviour that drives them to be more exploratory) to pass back and forth though a netting is advantageous to the health of the hive to which the bees belong. The applicant has observed that bees may crawl or walk through an aperture size of 6 to 10 mm but may not want to under normal behaviour. Although once though, a bee may have difficulty in (or be discouraged from) returning back to the hive due to the size of the aperture. Bees appear to be more willing to pass through an aperture size of about 10 mm to 24 mm, although they have to land on the netting first and crawl or walk through for the small sizes while for the larger sizes they are more willing to fly though. An aperture size of 13 mm or more, or 14 mm or more, or 15 mm or more, or 16 mm or more, or 17 mm or more, or 18 mm or more, or 19 mm or more, or 20 mm or more, or 22 mm or 24 mm or more is large enough for a bee to fly through without needing to land on the netting first. Aperture sizes of 10 mm and 16 mm will also provide bee access without needing to land on the net first, but not as freely as nets above 18 mm. Such an aperture size may be particularly advantageous in allowing bees to fly freely though the apertures of the netting and be particularly beneficial to the health of the hive to which they belong. Again, while not wishing to be bound by any particular theory, the applicant believes that aperture sizes that are sufficient for a bees to fly though freely are substantially beneficial to the general health of the hive.

The applicant recognises that a bee in flight can be considered to have a generally ellipsoid shape when viewed in transverse cross-section, and for this reason the aperture size of the netted window portion is defined herein with reference to the major and minor axes of the largest ellipse that may be scribed within an aperture in a mesh when the mesh is taut but not stretched in both a lateral and a longitudinal direction, rather than a circle shape as applies elsewhere in this specification. In some embodiments the apertures of the netted window portion are of a size such that the largest ellipsoid shape it may contain has a major axis of length 6 mm to 40 mm, or 8 mm to 35 mm, or 10 mm to 30 mm, or 15 mm to 25 mm, or 18 mm to 22 mm, and a minor axis of size 6 mm to 40 mm, or 6 mm to 18 mm, or 6 mm to 15 mm, or 6 mm to 12 mm, or 8 mm to 20 mm, or 8 mm to 18 mm, or 8 mm to 15 mm, or 8 mm to 12 mm. In some embodiments the major axis is between 18 and 22 mm, and the minor axis is between 10 mm and 24 mm.

In some embodiments the aperture size in the netted window portion of the netting is equal to or greater than an average wingspan for bees, in particular equal or greater than the average wingspan of the Apis mellifera, or is equal to or greater than 1.1, or 1.2, or 1.3, or 1.4, or 1.5, or 1.6, or 1.7, or 1.8, or 1.9, or 2 times the average wingspan for bees, or times the average wingspan for Apis mellifera.

In some embodiments the aperture size in the netted window portion is 4.5 to 100 mm, or 4.5 to 80 mm, or 4.5 to 60 mm, or 4.5 to 40 mm, or 4.5 to 30 mm or 4.5 to 25 mm, or 4.5 to 20 mm, or 4.5 to 15 mm, or 6 to 100 mm, or 6 to 80 mm, or 6 to 60 mm, or 6 to 40 mm, or 6 to 30 mm or 6 to 25 mm, or 6 to 20 mm, or 6 to 15 mm, or 8 to 100 mm, or 8 to 80 mm, or 8 to 60 mm, or 8 to 40 mm, or 8 to 30 mm or 8 to 25 mm, or 8 to 20 mm, or 8 to 15 mm, or 10 to 100 mm, or 10 to 80 mm, or 10 to 60 mm, or 10 to 40 mm, or 10 to 30 mm or 10 to 25 mm, or 10 to 20 mm, or 10 to 15 mm.

Apertures that are too large, while being permissive for bee flight may compromise other aspects of the netting material, such as the ability to provide sufficient shade or wind protection or exclude birds. Accordingly, in some embodiments the maximum aperture size of the netted window portion is less than 40 mm, or less than 30 mm, or less than 25 mm, or less than 23 mm or less than 20 mm or less than 18 mm.

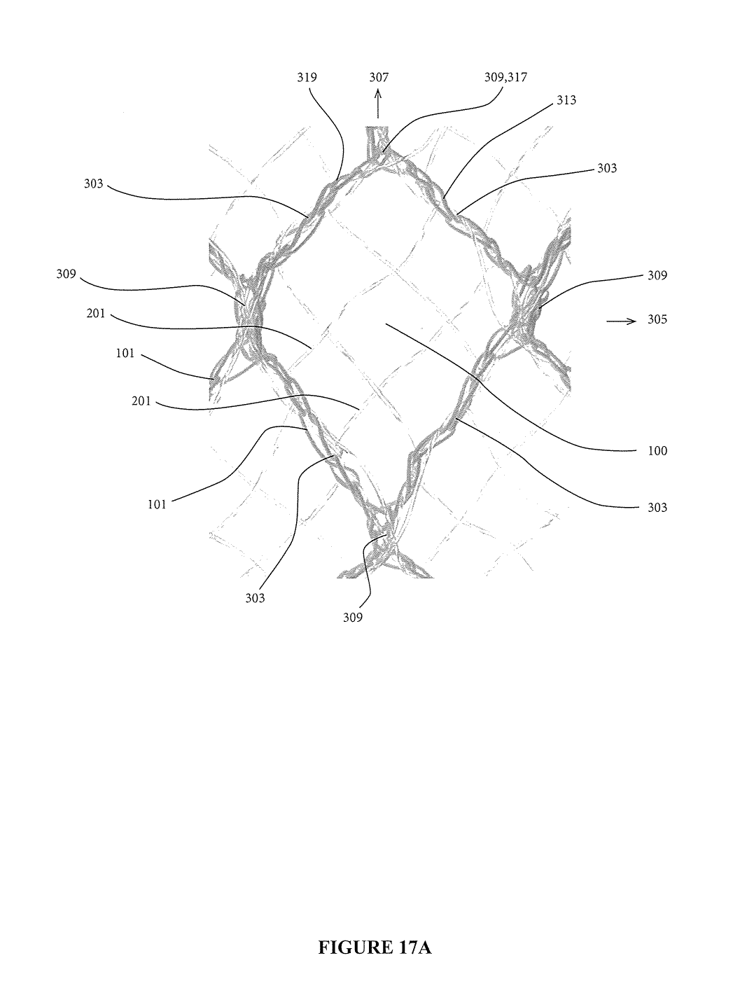

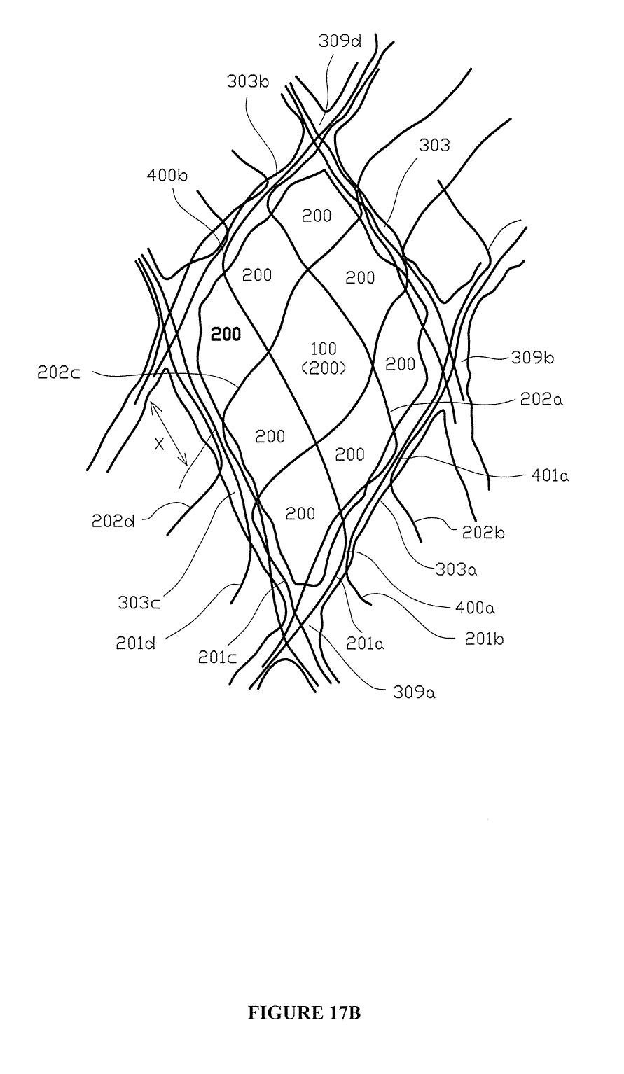

In some embodiments, the netted window portion 12 extends lengthwise along the netting material, and preferably substantially the full length of the netting material. In FIGS. 15 and 16 the lengthwise direction of the netting material is indicated by arrow 100. In some embodiments the main portion of the netting material and the netted window portion of the netting material are formed separately and subsequently joined together along a longitudinal edge of the main portion. For example, the window portion and the main portion may be knitted or woven separately to form a length of the window portion netting and a length of the main portion netting. These separate longitudinal portions are then subsequently joined together, for example by bonding, by stitching or by other joining means.

In some embodiments the netted window portion 12 is at a longitudinal edge 15 of the netting material, for example as illustrated in FIG. 11. Preferably in use the netting material is installed as a wall 10 with the netted window portion 12 located at a top of the wall, as shown in FIG. 11. Bees flying to and from the trees may enter and exit the tree or orchard area via the top region 12 of the netting material through the netted window area 12. In some embodiments the netted window portion covers 5 to 30%, or 5 to 20%, or 5 to 15%, or 5 to 10% of the width of the netting material. For example, in some embodiments the netting material may have a width of about 10 m and the netted window may have a width of about 1 m. The netted window portion may comprise extend lengthwise (or widthwise) along the material in the form of a band that is 80 mm to 2 m, or 100 mm to 1.5 m, or 200 mm to 1 m wide, or 400 mm to 600 mm wide, or about 0.5 m wide. The netted window portion may be in the form of a single band that extends lengthwise (or width wise) along the material, or may be in the form of multiple bands. In some embodiments, the bands of netted window portion may be 5 to 15 m apart, to 8 to 12 m apart, or about 10 m apart.

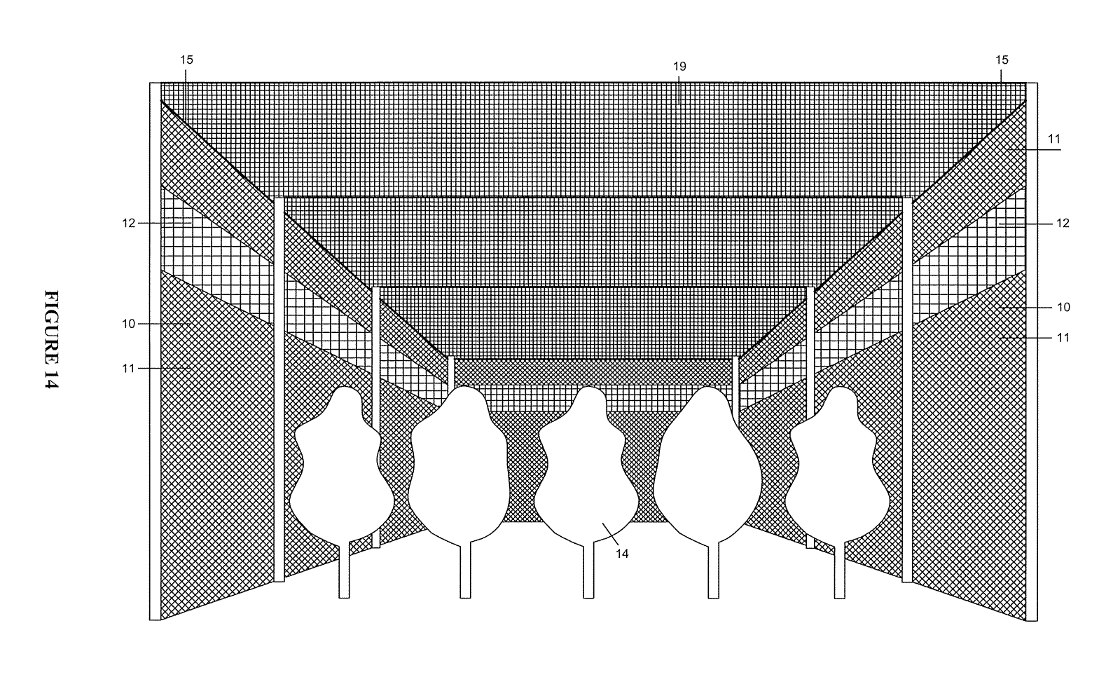

In some embodiments the netted window portion is provided around a perimeter of the netting material. For example as illustrated in FIG. 12, in some embodiments the ceiling netting 19 comprises a netted window portion 12 around the perimeter of the netting material. Bees may enter and leave the trees via the perimeter netted window portion of the ceiling netting 19. In some embodiments the netted window portion covers 5 to 30%, or 5 to 20%, or 5 to 15%, or 5 to 10% of the width of the netting material along each longitudinal edge of the netting material, and the same or similar width of netted window material may be provided along each lateral edge of the netting material. For example, in some embodiments the netting material may have a width of about 10 m and the netted window may have a width of about 0.5 m along each longitudinal edge and 0.5 m along each lateral edge, so that the netting material has a 0.5 m wide netted window portion around the perimeter of the netting material

In some embodiments, and with reference to FIG. 12A, the netted window portion 12 extends lengthwise along a region located between the longitudinal edges of the netting material, or extends lengthwise along a central portion of the width of the netting. In use, netting may be installed over spaced apart rows of plants. A netting with a window portion extending lengthwise along a region located between the longitudinal edges of the netting material (or extending lengthwise along a central portion of the width of the netting) may be installed above rows of plants such that the window portion is located generally above the spaces between the rows. This has the advantage that hail, which may pass through the larger apertures of the netted window portion more readily than the apertures of the main portion, is less likely to damage plants beneath the netting (or any fruit borne thereon).

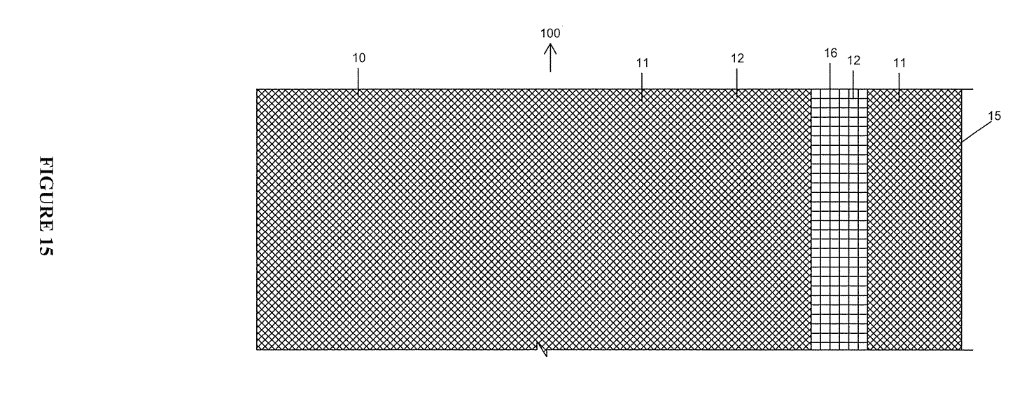

In the embodiment of FIG. 13, the ceiling netting 19 comprises a netted window portion 12 around the perimeter of the netting material, and the netting material installed as a wall includes a netted window portion 12 located at a top of the wall. Thus in this embodiment the netting enclosure has a netted window portion spanning a top corner area of the enclosure formed by four vertical walls 10 and a ceiling 19. The bees may enter and exit the trees via the top corner area provided by the top of the walls and the perimeter portion of the ceiling.

In some embodiments, the netting material may comprise a netted window portion along both longitudinal edges of the netting material. For example, the ceiling netting material 19 may comprise a netted window portion 11 along both longitudinal edges. This embodiment allows bees to enter and exit the trees 14 via longitudinal sides of the ceiling netting 19 covering the trees.

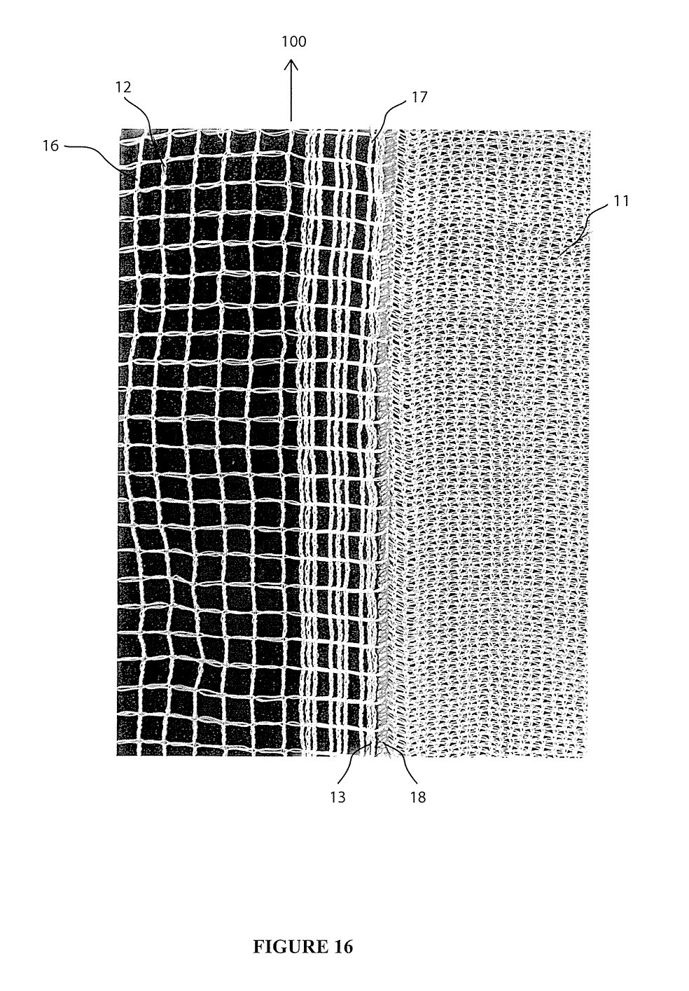

In some embodiments, the netted window area is spaced from the edge of the netting material, for example like the example illustrated in FIG. 14. In the illustrated example, the netted window is spaced from the top edge 15 of the netting material in use. In some embodiments, the netted window portion is spaced from a longitudinal edge 15 of the netting material by 5 to 30%, or 5 to 20%, or 5 to 15%, or 5 to 10% of the width of the netting material. For example, in some embodiments the netting material may have a width of 10 m and the netted window portion may have a width of about 1 m positioned about lm from a longitudinal edge of the netting material that would preferably form a top edge of the netting material in use. In some embodiments, the netting material may have a width of 20 m or more, with netted window portions extending lengthwise along the netting and having a width of 0.5 m, and about 10 m apart. The portion of the netting spanning between the netted window portion and the longitudinal edge of the netting material is in some embodiments preferably the same as the netting material of the main portion of the netting material.

In some embodiments, the netted window portion may be formed in areas of the netting material other than edge or longitudinal regions. For example, netting material used as a wall or ceiling netting material may have a netted window portion in a central location of the netting material. However, for ease of manufacture such embodiments may be less preferred.

In some embodiments the netted window portion and the main portion may be of the same basic knit pattern with the same or similar primary aperture size. A difference between aperture size of the main and netted window portions is achieved though use of one or more lay-in yarns crossing over the primary apertures of the main portion to divide the primary apertures of the main portion into smaller apertures. The netted window portion may have no lay-ins crossing its primary apertures. Alternatively, the number of lay-in yarns crossing the primary apertures of the main and netted portions, or the arrangement of how the lay-in yarns crossing the primary apertures of the netted and window portions, may be different to achieve a smaller aperture size in the main portion than that of the netted window portion. Such embodiments may achieve manufacturing advantages, in that a netting of the invention may be formed on a single loom employing a single basic knit pattern, with variation existing only as to how lay-in yarns are employed.

In some embodiments the netted window portion is comprised of stronger yarns than the main portion. For example, the yarns of the netted window portion may be of 600 denier or greater, or 700 denier or greater, or 800 denier or greater. This may be advantageous to achieve uniformity of strength across the netting as a whole, in particular, for embodiments that employ lay-in yarns in the main portion but not in the netted window portion. In some embodiments, the main portion of the netting comprises lay-in yarns that cross its primary apertures and the netted window portion comprises lay-in yarns that follow a path around the perimeter of the primary apertures, rather than crossing though them. Such an arrangement may also be useful for achieving uniformity of strength across the netting material as a whole.

For a netting material having a pillar knitted structure whereby the spacing between pillars, and/or the arrangement of crossover yarns, is altered to create a netted window portion, the yarns forming the pillars of the netted window portion, and/or the yarns forming the crossovers of the netted window portion may stronger or of greater denier to provide uniformity of strength. The skilled person will appreciate that the above concepts can be applied to other knit structures, and other knit structures are also encompassed in the invention.

In some embodiments the window portion and the main portion (or the plant protection portion) of the netting comprise a different knitting or weave pattern. Each portion may be formed separately and subsequently joined together. For example, in some embodiments the main portion 11 of the netting material comprises pillar based net, hexagonal, diamond or triangular apertures and the netted window area 12 comprises square or rectangular apertures.

Due to the smaller aperture size of the main portion 11 of the netting, the main portion of the netting may tend to have less stretch or is less susceptible to being pulled out of shape than the netted window portion 12 that has larger aperture sizes. To assist in preventing stretch in the window portion of the netting, in some embodiments the netted window portion has a knitted pillar construction. A pillar knitted construction comprises knitted pillars running along or across the netting material. There is little stretch in the netting material along the direction of the pillars 16. In some embodiments it may be preferable to have the pillars running longitudinally in the netting material so that the window portion of the netting material is less likely to stretch in the longitudinal direction of the netting material. The netting material may be pulled tight between lateral ends of the netting material in an installed condition with minimal stretch along the netting material.

As described above, and with reference to FIG. 16, in some embodiments the window portion and the main portion of the netting material are formed separately and subsequently joined together. In some embodiments, to assist with joining the window portion to the main portion of the netting the window portion comprises a longitudinal edge region 13 having a higher density construction than a remainder of the netted window portion. The higher density region is stitched or bonded or otherwise joined to the main portion of the netting to provide a join of sufficient strength. For example, in some embodiments the netted window portion 12 comprises a knitted pillar construction and the pillars 17 in the longitudinal edge region 13 are spaced closer together than in the remainder 12 of the netting window portion. The closer spacing of the pillars 17 provides additional yarns at the edge of the window potion 12 for joining with the main portion 11 of the netting. For example, in some embodiments the spacing between pillars 17 in the longitudinal edge region of the window portion of the netting material is 1 mm to 6 mm, or 2 mm to 5 mm, or 3 mm to 4 mm and the spacing between pillars 16 in the remainder of the netted window portion is 6 mm to 30 mm, or 6 mm to 25 mm, or 6 mm to 20 mm, or 7 mm to 19 mm, or 8 mm to 18 mm, or 9 mm to 17 mm, or 10 mm to 16 mm, or 11 mm to 15 mm or 12 mm to 14 mm.

In some embodiments the netting comprises a window identification means to signal to the bee where the netted window portion is located. The window identification means may be yarns of a different colour (from a bee's perspective) to the colour of other parts of the netting and that are located in close proximity to the netted window portion, or are used to form the netted window portion. A difference in colour of the netted window portion may also be achieved through use of a coloured lay-in in the yarns that form the window portion, laid around the apertures of the netted window portion rather than through them. Different shades, tone and hues of colour may also be used; all being referred to herein simply as different colour for simplicity.

By employing colour (from a bee's perspective) to signal to bees where a window is located, most of the yarns of the netting may be of makeup (e.g. solar radiation reflectance, absorbance and transmittance properties) suitable to promote growth and development of a crop under/beside the netting, while a relatively small proportion of coloured (form a bee's spersepctive) yarns can be used to signal to bees, or encourage bees, to pass though the netting at defined locations. The yarns useful for signalling the location of a window to bees may not necessarily be suitable to enhance the growth and development of a crop. The coloured regions may also be useful for bees to act as points of orientation, or landmarks, for return to the hive.

In some embodiments the netting material comprises a visual border between the main portion of the netting and the netted window portion. This may assist in providing a visual boundary for bees to be directed through the window area of the netting material.

In some embodiments where the window area and the main portion of the netting material are stitched together, for example as shown in FIG. 16, the netted window portion and the main portion of the netting may be stitched together using a yarn 18 that is a different colour to the colour of the main portion 11 of the netting material and the netted window portion 12 of the netting material. The different coloured yarn 18 may form the visual border between the main portion of the netting and the netted window portion. For example, in some embodiments, the stitching yarn 18 may be coloured purple, black, or red wherein the main portion or the main portion and the window portion may be knitted or woven from white yarns.

In some embodiments the netted window portion and the main portion of the netting may be stitched together using a yarn coloured darker (from bee's perspective) than a yarn forming the main portion and a yarn forming the netted window portion of the netting, to form the visual border between the main portion of the netting and the netted window portion.

A visual border or frame between the netted window portion and the main portion of the netting material may be created in other ways. For example, a coloured tape or strap of material may be fixed to the netting material at an edge of the netted window portion, or a strip of the netted window portion and/or the main portion may be coloured by paint for example. In some embodiments one or more yarns (for example warp yarns) in the netting material at a border between the netted window and main portions of the netting may be a different colour (from a bee's perspective) to the colour of the yarns in the netted window and main portions of the netting. In some embodiments a lay-in yarn that is a different colour (from a bee's perspective) to the colour of the yarns in the netted window and main portions of the netting may be provided at a border between the netted window and main portions of the netting.

In some embodiments the main portion 11 and netted window portion 12 are integrally knitted together, for example on a single knitting machine or two machines side-by-side, so that subsequent joining of the main and window portions after knitted is not necessary. For example, in some embodiments, a knit pattern in the netted window portion in one width area of the netting material is different to a knit pattern in the main portion in another width area of the netting material, the different knit patterns being simultaneously knitted in a single length of netting material. In some embodiments the difference in knit pattern results from the differing use of lay-in yarns in netted window and main portions. For example, the main portion may comprise lay-in yarns and the netted window portion may not.

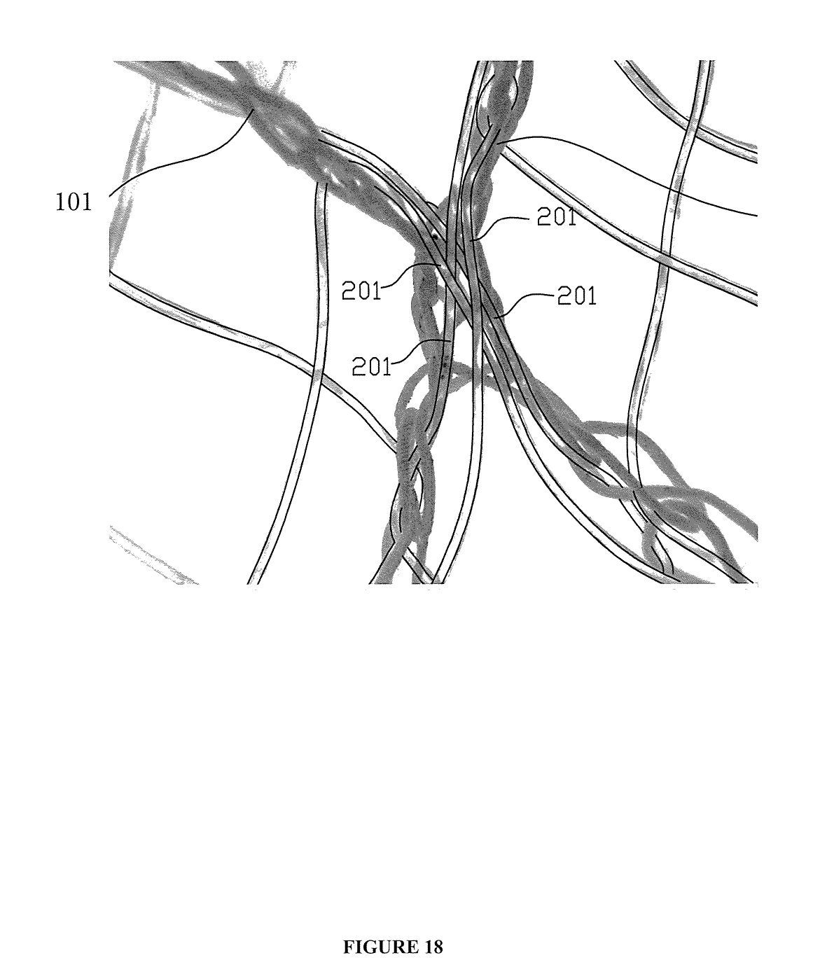

In some embodiments, the netting material of the invention comprises a plurality of primary yarns knitted to form a mesh construction having an arrangement of primary apertures defined by yarn intersections and yarn connecting portions between yarn intersections, and a plurality of secondary yarns in the main portion of the netting material, the secondary yarns crossing over the primary apertures to form secondary apertures within the primary apertures in the main portion of the netting. As the secondary yarns are not present in the netted window portion of the netting material, the aperture size in the netted window portion is equal to the aperture size of the primary apertures. The netting may be machine-knitted on a warp knitting machine or other knitting-machine. The netting comprises an array of mesh apertures. The mesh apertures of a netting material according to one embodiment are shaped as seen in FIGS. 17A and 17B, comprising four sides or yarn connecting portions and four yarn intersection points and are substantially uniform in shape and size. The orientation of the mesh apertures relative to the length direction 307 and width direction 305 of the netting need not be as shown in FIG. 17A. FIGS. 17A and 17B would typically be replicated throughout the major expanse of the netting. The netting may be finished with a different structure at each lateral edge, for example to include a finished edge, reinforced openings or other features.

With reference to FIG. 17A, the mesh aperture 100 is defined by yarn connecting portions 303. In the illustrated form four yarn connecting portions are arranged to form sides of a four sided aperture, which is aligned at generally 45 degrees to the length direction 307 and width direction 305 of the netting. In some embodiments the aperture may be a square or a diamond shape. The connecting portions 303 meet at yarn intersections 309.

In a netting material according to some embodiments of the present invention, the netting material comprises primary yarns 101 and secondary yarns 201. In some embodiments, each yarn 101, 201 in the netting generally proceeds in the length direction 307. The primary yarns are knitted together to form a mesh construction comprising primary apertures 100 throughout the netting material, in both the main portion of the netting and the netted window portion of the netting. In some embodiments, the primary yarns extend lengthwise, adjacent primary yarns being knitted or knotted or looped together at the yarn intersections 309. The primary yarns 101 extend along an alternating sequence of connecting portions 303 and intersections 309.

The primary yarns follow a path that is knitted, knotted or looped along each yarn connecting portion 303 defining the primary aperture. In the illustrated embodiment, two adjacent primary yarns are knitted, knotted or looped together at each intersection point 309. In some embodiments the netting material comprises a plurality of primary yarns each extending along a length of the netting in an approximate zig-zag path with alternating yarn intersections and connecting yarn portions, with adjacent primary yarns knitted, knotted or looped together at the yarn intersections. For example, yarns 313 and 319 are knitted and looped together at the intersection 317. The netting comprises rows of yarn intersections 309, said rows extending across either the width of the material or along the length of netting material, the yarn intersections of each row of yarn intersections 309 being staggered or offset with respect to its adjacent row of yarn intersections. Put another way, the netting comprises rows of apertures extending across either the width of the material or along the length of netting material, the apertures or each row offset compared to its adjacent row (for example, the rows may be offset as may be formed in a diamond or hexagonal knit pattern, rather than stacked as they may be in a square net pattern).

In a netting material according to some embodiments of the present invention, secondary yarns are provided in the main portion of the netting material. In the main portion of the netting, each secondary yarn is not knotted or looped, or at least not knotted or looped to the same degree of the primary yarn, in the yarn connecting portion. The primary yarn 101 is knitted, knotted or looped around the secondary yarn 201 in the yarn connecting portion. In other words, a secondary yarn 201 weaves back and forth or is threaded through knitted primary yarn 101 along the yarn connecting portion 303 or the yarn 201 is laying in the primary yarn 101. Secondary yarn 201 is not knitted, knotted or looped, but is retained by the knitting and looping of primary yarn 101, which passes around secondary yarn 201. The secondary yarn 201 is retained by the knitting or knotting or looping of the primary yarn without being knitted, knotted or looped in the yarn connecting portion 303, or at least not knotted or looped to the same degree as the primary yarn.

Each secondary yarn passes part way along a yarn connecting portion 303 and then extends from the yarn connecting portion 303 to cross over a primary aperture 100 to another yarn connecting portion defining that primary aperture 100. That is, the secondary yarn extends across the primary aperture 100 between a pair of yarn connecting portions. As at least one secondary yarn crosses between each pair of yarn connecting portions of an aperture 100, at least two secondary yarns cross over each primary aperture 100 thus defining at least four smaller secondary apertures within each primary aperture. Thus the main portion of the netting including secondary yarns has smaller apertures than the netted portion of the netting material that is without secondary yarns.

The skilled person will appreciate that more or less than 4 secondary yarns could be employed to create smaller of larger apertures, and such variations are included within the scope of the invention. By varying the number of secondary yarns used to cross over the primary apertures, and the position such yarns cross, and size of aperture in both netted window portion and main body portion, the apertures in each portion may be constructed to a size appropriate to permit or prohibit bee passage.

In some embodiments the netting material comprises a plurality of secondary yarns each of which extends along a length of the netting material in an approximate zig-zag path.

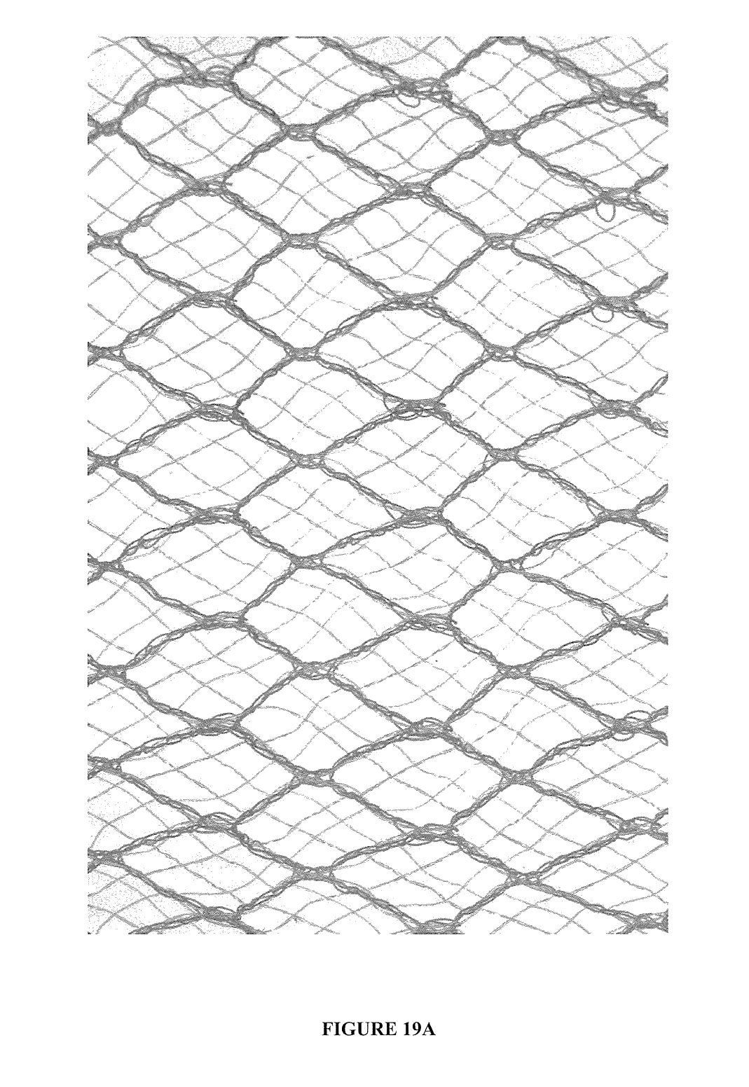

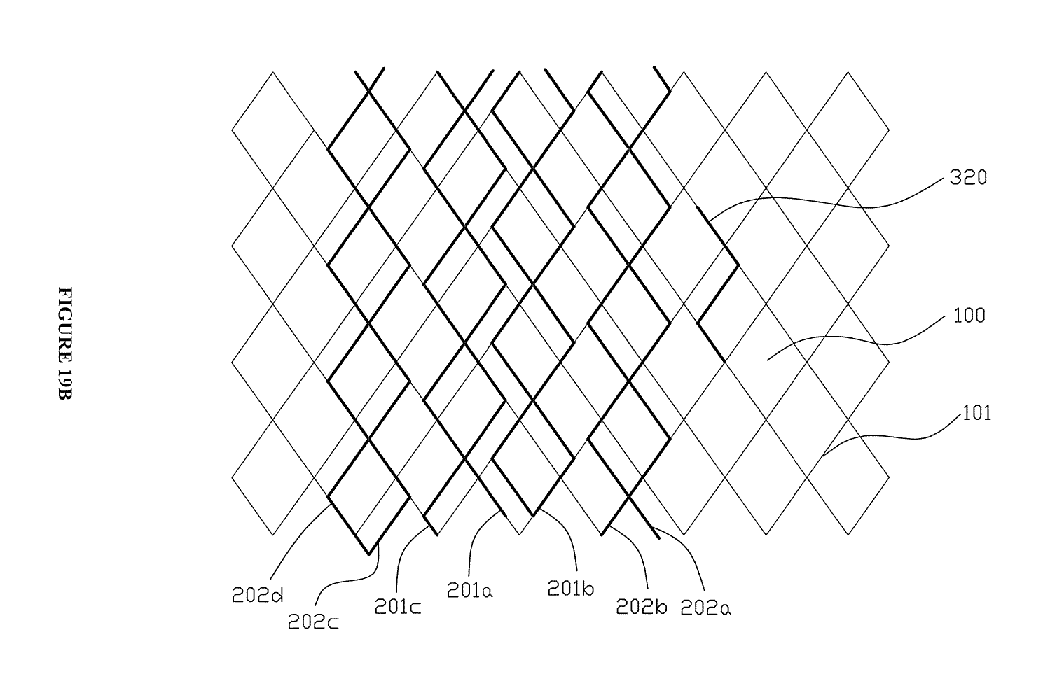

For example, each secondary yarn extends along the length of the netting material in an approximate zig-zag path and has a zig-zag pitch and amplitude the same as a zig-zag pitch and amplitude of the primary yarns. The zig-zag path of each secondary yarn is offset along a connecting yarn portion of the mesh construction by a distance, for example distance “x” illustrated in FIG. 17B. Thus each secondary yarn extending in a zig-zag pattern has a repeating portion (for example portion 320 indicated in FIG. 19B) that extends from an intersection point 309, partway along a yarn connecting portion 303, across a primary aperture 100 to the yarn connection portion 303 on the opposite side of the aperture, and then partway along the yarn connecting portion 303 on the opposite side of the primary aperture to the next yarn intersection 309 along the netting material. In some embodiments the secondary yarn is not knotted or looped in the yarn intersections of the netting material. Thus the secondary yarns extend along the netting material in a zig-zag path along yarn connecting portions and through or over yarn intersections and across primary apertures without being knitted, knotted or looped in the netting and is retained by the knitted, knotted or looped primary yarns in the yarn connecting portions and/or intersections of the netting. For example, each secondary yarn passes through or over a yarn intersection point 309 without a substantial change in direction. An exemplary intersection 309 is illustrated in greater detail in FIG. 18.

In some embodiments the secondary yarns may cross over primary apertures without passing along a yarn connection portion. For example each secondary yarn may pass orthogonally through a yarn connecting portion without passing along the yarn connecting portion.

As illustrated in FIG. 17B where the knitted primary yarns are shown in outline to aid with clarity in the path of the secondary yarns, in some embodiments, a secondary yarn, for example 201a, extends part way along a yarn connecting portion 303a from a yarn intersection 309a at a first end of the yarn connecting portion to a separation point 400a. The yarn diverges from or extends from the separation point 400a to pass across the primary aperture 100. An adjacent secondary yarn 201b enters the same yarn connecting portion 303a at or near to the separation point 400a and extends along the remainder of the yarn connecting portion 303a from the separation point 400a to the yarn intersection 309b at the second end of the yarn connecting portion. The secondary yarn 201a enters the yarn connecting portion 303b at the opposite side of the primary aperture 100 and extends along that yarn connecting portion from a separation point 400b to the yarn intersection 309d at the second end of the yarn connecting portion 303b. The adjacent secondary yarn 201b passes through or over the yarn intersection 309b at the second end of the yarn connecting portion 303a and into the yarn connecting portion of an adjacent aperture. Thus each yarn connecting portion comprises at least two adjacent secondary yarns, by example 201a and 201b. The adjacent secondary yarns for example 201a, 201b are illustrated in FIG. 17B to not overlap to add clarity in illustrating the paths of the secondary yarns in the netting material. However, in some embodiments the adjacent secondary yarns 201a, 201b may overlap at the separation point 400a. Preferably the adjacent secondary yarns 201a and 201b are not looped or intertwined together at the separation point 400a.

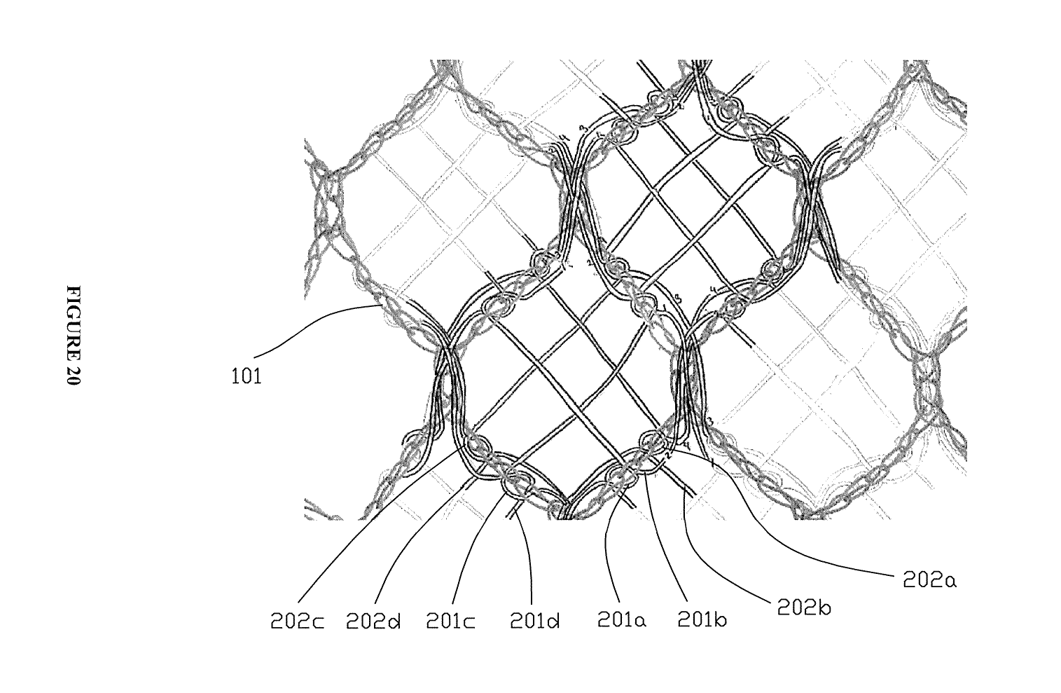

An adjacent yarn connecting portion 303c defining the aperture 100 and extending orthogonally (at an angle) to yarn connecting portion 303a similarly includes two adjacent secondary yarns 201c and 201d. Thus at least two secondary yarns 201a and 201c cross over the aperture 100 to define at least four secondary apertures within the primary aperture. That is, each yarn connecting portion 303 has a secondary yarn which is not knotted or looped in the yarn connecting portion that extends part way along the yarn connecting portion and extends from the yarn connecting portion to cross over a primary aperture to another yarn connecting portion defining the primary aperture so that at least two secondary yarns 201a, 201c cross over each primary aperture 100 to define at least four secondary apertures in each primary aperture. The zig-zag path of each secondary yarn is offset along a connecting yarn portion of the mesh construction by a distance equal to a size of a secondary aperture. In the illustrated embodiment there are four pairs of adjacent secondary yarns that extend partially along the yarn connection portions of a primary aperture 100; for example secondary yarns 201a and 201b, 201c and 201d, 202a and 202b, and 202c and 202d, as illustrated in FIG. 17B. These eight secondary yarns that are shown with reference to a single primary aperture in FIG. 17B are shown spaced apart in FIG. 19B to illustrate the zig-zag path of the secondary yarns through the netting material. FIG. 20 provides a further illustration of the main portion of a netting material according to some embodiments of the present invention with four pairs of secondary yarns 201a and 201b, 201c and 201d, 202a and 202b, and 202c and 202d shown threaded through the knitted primary yarns 101. In FIG. 20, the bending or curve of the secondary yarns as they change direction through the knit of the primary yarns is exaggerated for ease of displaying the path of the secondary yarns.

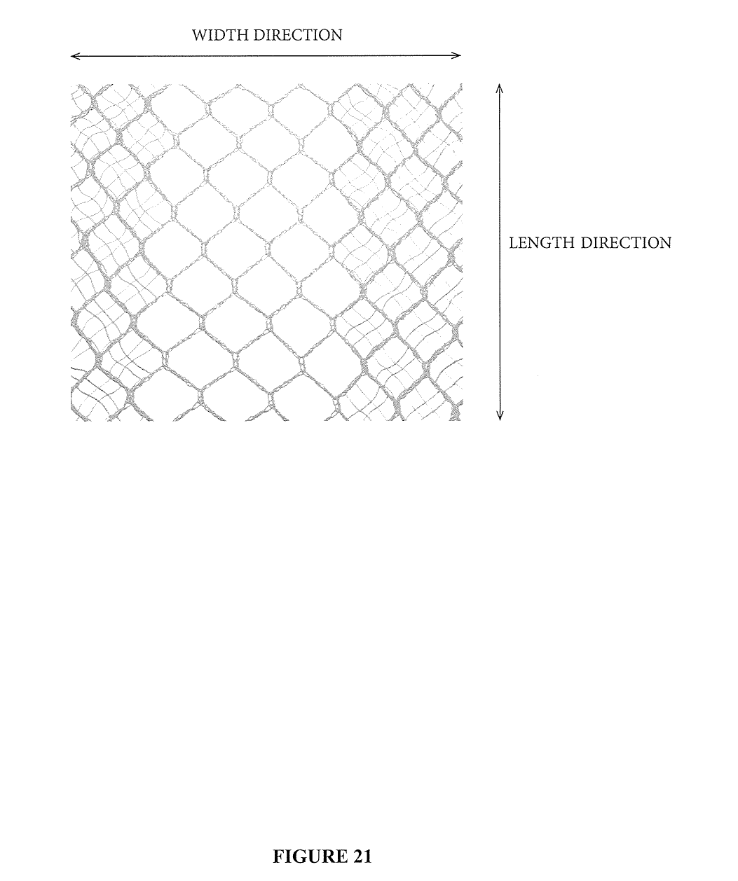

In the illustrated embodiment, each connecting yarn portion 303 comprises one pair of secondary yarns, for example secondary yarns 201a and 202a in yarn connecting portion 303a and secondary yarns 201c and 202c in yarn connecting portion 303c. In each yarn connecting portion the pair of secondary yarns pass part way along the connecting yarn portion and extend from the connecting yarn portion to cross over the primary aperture 100 in a spaced apart relation to a connecting yarn portion on an opposite side of the primary aperture. Therefore, two pairs of secondary yarns 201a, 202a and 201c, 202c cross over each primary aperture 100 to define nine secondary apertures 200 in each primary aperture 100. Thus, the aperture size in the netted window portion (which lacks secondary yarns) of the netting material is 3-times the size of the aperture size in the main portion of the netting material. FIG. 21 shows a section of a netting material comprising a mesh of primary apertures in the main portion 11 and netted window portion 12 of the netting material, and with secondary yarns in the main portion 11 of the netting material so that the aperture size in the main portion is nominally one third the size of the apertures in the netted window portion. In one embodiment the primary aperture size may be about 18 mm, so that the aperture size in the main portion of the netting is nominally 6 mm and the aperture size in the netted window portion is 18 mm. In some embodiments, each of a majority of connecting yarn portions 303 comprise more than two secondary yarns each of which extend partway along the yarn connecting portion and extend across the primary aperture in a spaced apart relation. For example, in one embodiment each connecting yarn portion may comprise three secondary yarns 200 extending partway along the connecting yarn portion 303 and across a primary aperture 100 in a spaced apart relation to the connecting yarn portion on the opposite side of the primary aperture so that the crossing secondary yarns extending from adjacent connecting yarn portions (e.g. connecting yarn portions 303a and 303c) define sixteen secondary apertures within the primary aperture.

In some embodiments the secondary apertures 200 and the primary apertures 100 have the same or similar aspect ratio. For example, in an embodiment where a single secondary yarn extends from each yarn connection portion 303 across the aperture, the yarn separation point 400a is located midway between the yarn intersection points 309 so that the secondary apertures are equal size, each secondary aperture being half the size of a primary aperture. In some embodiments, a pair of secondary yarns extends from each yarn connecting portion across the primary aperture, a first one of the pair of secondary yarns extending from a separation point 400a positioned one third along the length of the yarn connecting portion 303 and a second one of the pair of secondary yarns extending from a separation point 401a positioned two thirds along the length of the yarn connecting portion, so that the two pairs of secondary yarns crossing the primary aperture define nine equal sized secondary apertures each being 1-third the size of the primary aperture. In practice, due to movement of the yarns within the netting and the yarns not being tightly retained or knotted in the netting between intersections and separation points the sizes of the secondary apertures and primary apertures vary such that the apertures are not necessarily equal size even when the netting is manufactured to a netting pattern comprising equal sized secondary apertures and equal sized primary apertures. Thus, it is to be understood that in this specification and claims, when it is stated that apertures are of an equal size or have the same aspect ratio or of a general shape, such statements refer to a nominal netting pattern rather than a specific netting example where the apertures size and shape may be pulled out of nominal size and/or shape.

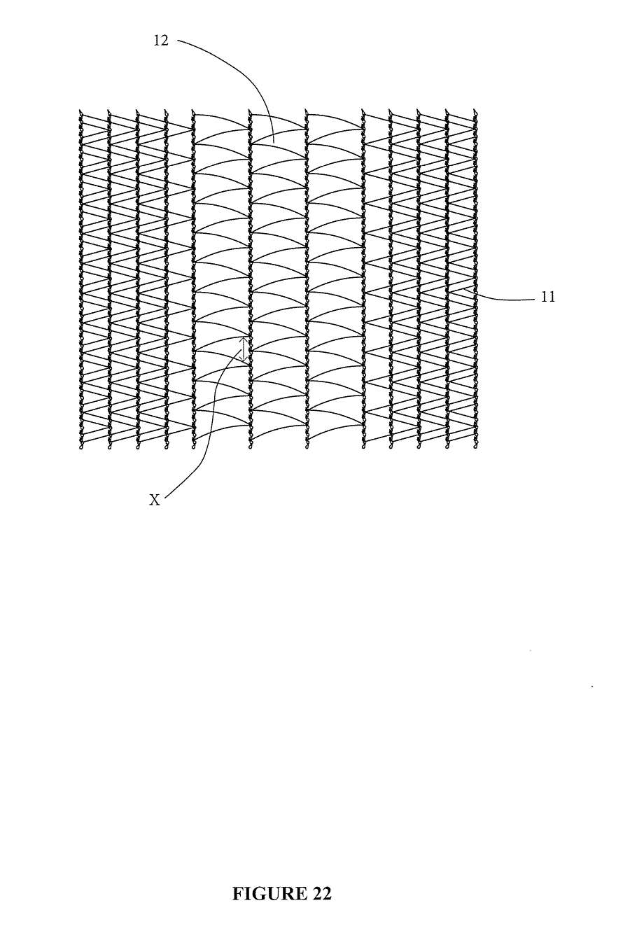

In some embodiments the netted window portion is formed formed of fabric having a pillar knitted construction. In a typical pillar knit construction, each knitted pillar may include three yarns, one yarn that crosses back and forth along the length of the netting between the pillar and an adjacent pillar located on one side of the pillar, another yarn that crosses back and forth along the length of the netting between the pillar and an adjacent pillar located on the other side of the pillar, and a pillar yarn that is knitted together with the other two crossing yarns to form the pillar along the length of the netting material. With reference to FIG. 22, the netting is comprised of a main portion 11 and a netted window portion 12. The yarns crossing between the pillars of the fabric of the netted window portion are arranged to form larger apertures than those for the main portion of the fabric. In some embodiments the spacing between pillars of the netted window portion is 24 mm, and the distance along a pillar between the knots of a yarn that crosses back and forth between two pillars (i.e. distance X on FIG. 22) is 20 mm. In some embodiments the distance between pillars of the main portion of the material may be 8 mm, or 12 mm, with the yarns that cross back and forth between pillars crossing back and forth across a width of three pillars (i.e. crossing back and forth across a grouping of two boundary pillars and an intermediate pillar located between them), and being knotted at each pillar. The distance between knots on a boundary pillar of a yarn crossing back and forth between pillars may be 20 mm. Each intermediate pillar may form a boundary pillar for an adjacent yarn crossing back and forth between three pillars, as illustrated in FIG. 22, to repeat the knit pattern. The section of material is shown having a main portion of the material either side of the netted window portion. In some embodiments the netted window portion is at the edge of the main portion, rather than intermediate two sections of main portion.

In some embodiments the netted window portion 12 is knitted or woven from clear yarns (including un-pigmented yarns or yarns comprising colourless or near colourless pigments), so that the material of the netted window portion does not provide a visual barrier or provides a visual guide, to bees attempting to navigate through the netting material. For example the netted window material may be knitted from clear monofilaments.

In some embodiments the netted window portion 12 may, from a bee's perspective, be a different colour or contrasting colour to the colour of the main portion 11 of the netting material. For example, where the main portion of the netting material is knitted or woven from white yarns, the netted window portion may be knitted or woven from yarns of a colour other than white. Alternatively, both netted window and main portions may, from a human's perspective, appear white but differ in colour from a bee's perspective due to each have different UV reflective properties. In some embodiments, the netted window portion may be knitted or woven from coloured yarns, for example monofilaments coloured black, violet, indigo, purple, red, orange, blue, green, yellow or bee purple or a combination of these colours. “Bee purple” is a colour comprised of mixtures of greenish (yellow) wavelengths (roughly 540 nm) with ultraviolet. In a preferred embodiment the netted window portion is knitted or woven from red coloured yarns. In this specification and claims, the term ‘colour’ is also intended to refer to black, white, clear and shades of grey. It may also include colourless.

In other embodiments the netted window portion is knitted or woven from ‘bee purple’ coloured yarns. Bees have a different visible light spectrum to humans. The human visible spectrum extends to longer wavelengths than the bee visible spectrum. Bees cannot see longer wavelength reds that humans can see. However, the bee visible spectrum extends to shorter wavelengths and can see ultraviolet wavelengths in the range of about 300 nm to 400 nm, this including aspects of ‘bee purple’ that is outside the human visible spectrum. In some embodiments the colour of the netted window portion is a longer wavelength red that is outside the colour spectrum of a bee, such that bees see the yarns of the netted window portion as black. For example the window portion may be a red with a wavelength of greater than about 650 nm.

In some embodiments, the netted window portion may be formed from yarns that absorb more ultraviolet light than yarns forming the main portion of the netting material or the other way around, the window will be ultraviolet reflecting while the main portion ultraviolet absorbing. A bee will see this difference in ‘colour’; however the yarns of both the netted window and main portions of the netting material may appear white to the human eye. For example, in some embodiments, the netted window portion may be formed from yarns that are UV reflecting white whereas the main portion of the netting material may be formed from non UV reflecting white, or vice versa. The contrast in colour within the bee visible spectrum may help bees to distinguish between the window and main portions of the netting to assist bees travel into and out of an area enclosed by the netting material.

Coloured yarns may be formed of coloured material (for example monofilaments formed from red pigmented plastic), or coloured yarns may be painted or otherwise coloured after the netting material has been knitted (for example monofilaments formed from white plastic and subsequently painted red after the netting material is formed). Thus a netting material knitted from red yarns may be knitted from white yarns and subsequently painted red after knitting.

By colouring the netted window a colour different to the colour of the main portions of the netting, the travel of bees through the netted window portion may be improved. For example, in field trials, a netted window portion coloured red in a netting material having a white main portion was found to improve the travel of bees into and out of the area protected by the netting material, compared to a netting material with a white main portion and a white netted window portion.

In some embodiments, the present invention relates to an installation of netting material. The installation comprises four netting walls and a netting ceiling to form a netted enclosure. One or more of the netting walls or the netting ceiling comprises a netting material with a main portion and a netted window portion as described in various embodiments above.

In some embodiments, one or more of the netting walls 10 comprises a netting material with a main portion and a netted window portion as described in various embodiments above. In a preferred embodiment, each of the four netted walls comprises a main portion and a netted window portion. In a preferred embodiment, each of the four netted walls comprises a netting material with a main portion and a netted window portion at the longitudinal edge of the netting material at the top of the wall.

In some embodiments, the ceiling netting comprises a main portion and a netted window portion as described in various embodiments above. In a preferred embodiment, the ceiling netting comprises a netting material with a main portion and a netted window portion around the perimeter of the netting material.

In some embodiments, where one or more walls have a netted window portion 12, the ceiling may or may not have a netted window portion. In some embodiments, where the ceiling netting has one or more netted window portions, the walls may or may not have a netted window portion.

In a preferred embodiment, each of the four netted walls comprises a netting material with a main portion and a netted window portion at the longitudinal edge of the netting material at the top of the wall, and the ceiling netting comprises a netting material with a main portion and a netted window portion around the perimeter of the netting material, so that the netted enclosure has a netted window portion spanning a top corner area of the enclosure formed by the walls 10 and the ceiling, as shown in FIG. 15.

In some embodiments, the main portion of the ceiling netting may be a different colour to the colour of the main portion of the wall netting. In some embodiments the netted window portions of the walls and/or ceiling are a colour that is different to the colour of the main portions of the walls and ceiling. For example, in some embodiments the main portion of the ceiling netting is white and the main portion of the wall netting is grey, and the netted window portions are unpigmented (i.e. clear/colourless) or a colour other than white and grey, for example red, blue, green or yellow, or other example provided above. In a preferred embodiment the netted window portions are coloured red. Grey or similar colours visually may be used in the wall portions so that the wall portions better blend into the environment.

In some embodiments the apertures of the netted window portion are sufficiently small to prevent birds passing through the netting material.

The above example of a netting material comprising a main portion suitable for use as wind protection is provided. However, the main portion of the netting may be suitable for other uses, for example protection against excessive sun or protection against hail stones. Such netting materials may have an aperture size too small to allow bees to pass.

In some embodiments, at least the main portion of the material may comprise pigment to influence its solar radiation reflection, absorption or transmittance properties, which may be particularly desirable in horticultural applications. In some embodiments the main body of the material may:

absorb more than 40%, or more than 50%, or more than 60%, or more than 70%, on average, of solar radiation across the wavelength range 280 to 400 nm; and

transmit more than 30%, or more than 50%, or more than 70%, or more than 80%, or more than 90%, on average, of solar radiation across the wavelength range 400 to 700 nm; and either

reflect more than 40% or more than 50%, on average, of solar radiation across the wavelength range 700 to 2500 nm; or

absorb more than 30% or more than 40%, on average, of solar radiation across wavelength range 700 to 2500 nm.

Such a material may be useful for horticultural applications requiring high UV protection while allowing some visible and infra-red light through, and for hail exclusion or wind protection.

In some embodiments a least the main portion of the material may:

absorb more than 50%, or more than 70%, or more than 90% of solar radiation across wavelength range 280 to 2500 nm.

Such a material may be useful for horticultural applications requiring shading from the sun.

In some embodiments at least the main portion of the material may:

absorb more than 40%, or more than 50%, or more than 60%, or more than 70%, on average, of solar radiation across the wavelength range 280 to 400 nm; and

reflect more than 40%, or more than 50%, or more than 60%, or more than 70%, on average, of solar radiation across the wavelength range 400 to 700 nm; and either

reflect more than 30% or more than 50%, or more than 70%, on average, of solar radiation across the wavelength range 700 to 2500 nm; or

absorb more than 1530% or more than 50%, on average, of solar radiation across wavelength range 700 to 2500 nm.

Such a material may be useful for horticultural applications requiring high UV absorbency and high visible light reflection.

In some embodiments a least the main portion of the material may:

absorb more than 50%, or more than 70%, or more than 90% of solar radiation across wavelength range 280 to 400 nm; and

transmit more than 50%, or more than 60% of solar radiation across the wavelength range 400-2500 nm.

Such a material may be useful for horticultural applications requiring high UV absorbency and high visible light transmission. Such material is also useful as insect, hail, and wind protection.

In some embodiments a least the main portion of the material may:

reflect more than 40%, or more than 60%, or more than 80% of solar radiation across wavelength range 280 to 2500 nm.

Such a material may be useful for horticultural applications requiring shading from the sun.

The skilled person will appreciate that the present invention can be achieved using a variety of knits and weaves. For example, a netting material according to some embodiments of the invention may comprise a pillar knit construction, a diamond knit construction having a mesh with diamond shaped apertures, or a hexagonal knit construction having a mesh with hexagonal knit constructions.

The foregoing describes the invention including a preferred form thereof, alterations and modifications as will be obvious to those skilled in the art are intended to be incorporated in the scope hereof, as defined in the accompanying claims.

1. A netting material having a length dimension and a width dimension smaller than the length dimension comprising:
a main portion comprising apertures of a first aperture size and shape,
a netted window portion comprising apertures of a second aperture size and shape,
wherein the apertures of the netted window portion are of sufficient size and shape to allow bees to pass through the netting material and the apertures of the main portion are of sufficient size and shape to substantially prevent bees passing through the netting material, and
wherein the netting material comprises a window identifier to assist bees in identifying the netted window portion.

2. The netting material according to claim 1 wherein the netted window portion extends lengthwise along the netting material.

3. The netting material according to claim 2 wherein the netted window portion extends substantially the full length of the netting material.

4. The netting material according to claim 1 wherein the netted window portion covers 2 to 30%, or 5 to 30%, or 5 to 20%, or 5 to 15%, or 5 to 10% of the width of the netting material.

5-10. (canceled)

11. The netting material according to claim 1 wherein the netted window portion material extends longitudinally along or near the centre of the width of the netting material.

12-15. (canceled)

16. The netting material according to claim 1 wherein yarns forming the netted window portion are stronger or of greater denier than yarns forming the main portion.

17-20. (canceled)

21. The netting material according to claim 1 wherein the window identifier comprises window identification yarns, said window identification yarns being yarns that, from a bees perspective, are different in colour (including different shades, tones or hues) to the yarns of the main portion of the material.

22. The netting material according to claim 21 wherein yarns which form the netted window portion comprise window identification yarns.

23. (canceled)

24. The netting material according to claim 21 wherein the window identification yarns are in the form of a lay-in laid into knitted yarns of the netted window portion.

25. The netting material according to 21 wherein the netted window portion has a length longer than its width and the window identification yarns form a band or bands of colour located to frame longitudinal edges of the netted window portion.

26-27. (canceled)

28. The netting material according to claim 21 wherein the window identification yarns are of colour white, black, ultra violet, indigo, violet, blue, purple, bee purple, green, yellow or orange or red, or a combination of such colours.

29-32. (canceled)

33. The netting material according to claim 21 wherein the yarns forming the main and netted window portions of the netting are white (from a human perspective) and the window identification yarns (whether they form the netted window portion itself or otherwise) differ in their reflectivity profile across the wavelength range 280 to 400 nm compared to the yarns of the main portion, and/or differ in their reflectivity profile across the wavelength range 400 to 620 nm compared to the yarns of the main portion.

34. The netting material according to claim 21 wherein the yarns forming the main and netted window portions of the netting are white (from a human perspective) and the window identification yarns (whether they form the netted window portion itself or otherwise), on average, reflect more or less solar radiation across the wavelength range 280-400 nm, and/or reflect more or less solar radiation across the wavelength range 400-620 nm.

35. The netting material according to claim 1, wherein the apertures of the main portion are of a aperture size less than 1 mm or 1 mm to 6 mm, or 1 mm to 5 mm, or 2 mm to 4 mm, or 2 mm to 3 mm.

36. (canceled)

37. The netting material according to claim 1, wherein the aperture size of the apertures in the netted window portion is to 6 mm to 24 mm, or 8 mm to 22 mm, or 10 m to 20 mm, or 12 mm to 19 mm, or 14 mm to 19 mm, or 16 mm to 19 mm

38. (canceled)

39. The netting material according to claim 1 wherein the apertures of the netted window portion have a size and shape sufficient to allow a honey bee to pass through by crawling/walking.

40-65. (canceled)

66. The netting material according to claim 1 wherein said material is of pillar knit construction comprising pillars and crossover yarns crossing back and forth between and along the length of the pillars, and
wherein the pillars and/or the crossover yarn(s) in the main portion of the netting are arranged such that the main portion of the netting comprises apertures of a size and shape sufficient to substantially prevent bees passing through, and
wherein the pillars and/or the crossover yarn(s) in the netted window portion of the netting are arranged such that the netted window portion of the netting comprises apertures of a size and shape sufficient to allow bees to pass through.

67. (canceled)

68. A netting material having a length dimension and a width dimension smaller than the length dimension comprising:
a main portion comprising apertures of a size and shape that bees may pass through but, from a bee's perspective, comprise a colour that deters them from doing so such that there is little or no bee passage through the netting, and
a netted window portion comprising apertures of a size and shape that bees may pass though and, from a bee's perspective, comprise a colour that bees will, when compared to the main portion, more willingly pass though.

69-70. (canceled)

71. A netting material having a length dimension and a width dimension much smaller
than the length dimension comprising:
a main portion comprising apertures of a first aperture size,
a netted window portion comprising apertures of a second aperture size, wherein the second aperture size is larger than the first aperture size,
the apertures of the second size sufficiently large to allows bees to pass through the netting material and the apertures of the first size sufficiently small to prevent bees passing through the netting material, and
wherein the netting material comprises a window identifier to assist bees in identifying the netted window portion.

72-85. (canceled)

86. The netting material according to claim 1 wherein the window identifier comprises window identification yarns and wherein the window identification yarns reflect more or less UV than the main portion.
